(19) United States
(12) Patent Application Publication
(10) Pub. No.: US 2011/0299188 A1
(43) Pub. Date: Dec. 8, 2011

(54) MAGNETIC HEAD SLIDER AND MAGNETIC DISK DRIVE

(75) Inventors: Kyosuke ONO, Hachioji (JP); Junguo XU, Kasumigaura (JP); Masaru FURUKAWA, Fujisawa (JP)

(73) Assignee: HITACHI, LTD., Tokyo (JP)

(21) Appl. No.: 13/080,930

(22) Filed: Apr. 6, 2011

(30) Foreign Application Priority Data
Apr. 9, 2010 (JP) 2010-090295
Feb. 8, 2011 (JP) 2011-025270

(51) Int. Cl. G11B 5/02

(52) U.S. Cl. 360/59; G9B/5.026

(57) ABSTRACT

A magnetic head slider having a thermal microactuator capable of efficiently transmitting thermal expansion displacement in the vicinity of a heating element to the region of a read/write element and thereby enabling high-speed displacement response is realized. The magnetic head slider comprises a slider substrate and a thin film stack part formed on the slider substrate. The thin film stack part includes a read/write element for reading and writing data and one or more heating elements arranged on one side or on each side of the read/write element in regard to a direction corresponding to the track width direction for generating heat in response to energization. Further, a low Young's modulus layer (made of a material having a low Young's modulus or void) is arranged between the slider substrate and the thin film stack part.

### CLAIM OF PRIORITY

The present application claims priority from Japanese applications JP 2010-90295 filed on Apr. 9, 2010 and JP 2011-25270 filed on Feb. 8, 2011, the content of which are hereby incorporated by reference into this application.

### BACKGROUND OF THE INVENTION

1. Field of the Invention

The present invention relates to a magnetic head slider and a magnetic disk drive. In particular, the invention relates to a magnetic head slider having a thermal actuator structure taking advantage of thermal expansion, and a magnetic disk drive employing such a magnetic head slider.

2. Description of the Related Art

For high accuracy positioning of a magnetic head slider over a track on a magnetic disk, the so-called “two-stage actuator”, including a microactuator arranged in the vicinity of the magnetic head slider, has been proposed. There are three known types of microactuators: a suspension driving type (driving a suspension which supports the magnetic head slider), a slider driving type (driving the magnetic head slider alone with respect to the suspension), and a magnetic head driving type (driving the magnetic head part alone with respect to the main body of the slider using an actuator mounted on the slider itself).

For example, JP-A-2009-170014 discloses a magnetic head driving type microactuator for a magnetic head slider proposed by the applicant of the present invention. This magnetic head slider is equipped with a head positioning thermal actuator in which a heating element is energized to cause thermal expansion of the material in the vicinity of the heating element and the track positioning of the magnetic head is carried out by use of the thermal expansion.

The magnetic head slider described in JP-A-2009-170014 includes a thin film stack part 42 stacked on the rear end of a slider substrate 41 made of Al₂O₃TiC. A read/write element 20 is formed in a central part of the thin film stack part 42. A heating element 21 is arranged at a lateral position several tens of microns apart from the read/write element 20. An intermediating part 25 transmits the thermal expansion in the vicinity of the heating element 21 to the read/write element 20. Since these elements are formed integrally by a thin film formation technology, the intermediating part is made of the material (generally, Al₂O₃) filling up the region other than the head or the heating element.

In the manufacture of the magnetic head slider having the magnetic head driving type microactuator, the heating element is formed in the same thin film formation process together with the read/write element in consideration of productivity. In general, the read element is made of a special material, the coil of the write element is made of copper, the heating element and the shield film are made of NiFe, and Al₂O₃ is used for the other part. Therefore, the temperature rise of the heating element, the thermal expansion and the transmission property of the thermal expansion to the head are strongly affected by physical property values (Young's modulus, thermal conductivity, specific heat, thermal expansion rate, etc.) of the Al₂O₃ material. Further, since the thin film stack part 42 (made principally of Al₂O₃) is stack up in close contact with the rear end face of the slider substrate 41 made of Al₂O₃TiC (generally called “AlTiC”), the properties of the head positioning thermal actuator are affected considerably by physical properties of the Al₂O₃TiC material in cases where the distance between the slider body (slider substrate 41) and the heating element in the thin film stack part 42 is short.

### SUMMARY OF THE INVENTION

According to the simulation for the displacement response of the head to the input electric power in consideration of the physical properties of those materials constituting the magnetic head slider, the displacement of the head is 4-8 nm which is achieved by the electric power input of permissible input electric power (50-100 mW) to the heating element in the conventional heating element structure described in JP-A-2009-170014. This satisfies the displacement necessary for the high accuracy positioning required in the near future (track pitch: 50 nm). However, the time response of the head to the stepwise input power supplied to the heating element is as slow as at least approximately 0.2-0.3 ms in terms of the time constant. This corresponds only to a maximum driving frequency band of approximately 0.8 kHz at most. Thus, the properties required of the high accuracy positioning actuator cannot be satisfied unless any further improvement is made.

The time constant is mainly dominated by the responsiveness of the thermal expansion in the vicinity of the heating element and in the transmitting part (caused by the temperature rise) to the electric power input to the heating element. In order to enhance the responsiveness, it is important that the part in the vicinity of the heating element can be heated instantly and uniformly throughout the whole thickness, the cooling effect on the head slider by thermal conduction to the air flow and the disk surface (in the close vicinity of the head slider) is enhanced, and the temperature-rising region in the stationary state is restricted to the part in the vicinity of the heating element. According to the simulation, the cooling effect on the slider's air bearing surface is actually strong and the part heated by the energization and contributing to the thermal expansion is restricted to a region within approximately 10 μm of the heating element to the right or left of the heating element. Therefore, it has become clear that the thermal expansion in the vicinity of the heating element is transmitted to the head in the form of elastic strain in regions farther than approximately 10 μm from the heating element.

It is therefore an object of the present invention to provide a magnetic head slider having a thermal actuator structure capable of efficiently transmitting the thermal expansion displacement in the vicinity of the heating element to the region of the read/write element and thereby enabling high-speed displacement response.

Another object of the present invention is to provide a magnetic disk drive capable of achieving high accuracy positioning by converting high displacement efficiency of the read/write element to improvement in the response speed.

In accordance with an aspect of the present invention, there is provided a magnetic head slider flying above a rotating magnetic disk and reading and writing data from/to the magnetic disk, comprising: a read/write element for executing the reading/writing of data; at least one heating element arranged in a width direction of the magnetic head slider with respect to the read/write element for generating heat in response to energization; a thermal expansion transmitting part lying between the heating element and the read/write element for transmitting thermal expansion caused by the heating of the heating element and thereby displacing the read/write element in the width direction; and a thermal displacement restriction limiting part formed in a region covering at least part of the region of the thermal expansion transmitting part for limiting restriction on the displacement in the width direction by the thermal expansion transmitting part.

In a preferred embodiment, the magnetic head slider is made up of a slider substrate and a thin film stack part formed on a rear end face of the slider substrate. The thermal displacement restriction limiting part is configured as a low Young's modulus part which is made of a material having a Young's modulus lower than that of the thin film stack part, the thermal displacement restriction limiting part being formed in the thin film stack part facing the slider substrate so as to cover at least part of the read/write element, the thermal expansion transmitting part and the heating element in the width direction of the magnetic head slider.

Preferably, the thermal displacement restriction limiting part is a void having prescribed width, depth and thickness.

Preferably, the thermal displacement restriction limiting part is filled in with a nonconductive ceramics material and is partially formed in a region forming a air-bearing surface of the slider and in a region substantially corresponding to part of the area of a protrusion control heating element which is used for controlling protrusion of the air-bearing surface.

Preferably, the thermal displacement restriction limiting part is filled in with a nonconductive ceramics material in a region in the vicinity of a air-bearing surface of the slider and in a region substantially corresponding to part of the area of a protrusion control heating element which is used for controlling protrusion of the air-bearing surface so as not to be open to the air-bearing surface, and the void is formed to extend to a back surface of the slider opposite to the air-bearing surface so as to be open to the back surface.

Preferably, the void is filled in with a nonconductive ceramics material in a T-shape. The top of the T-shaped part forms an air bearing surface of a air-bearing surface of the slider.

Preferably, the low Young's modulus part is implemented by a low Young's modulus layer which is made of a material having a Young's modulus lower than that of the slider substrate and that of the thin film stack part.

Preferably, thermal conductivity of the material forming the low Young's modulus layer is sufficiently lower than that of Al₂O₃TiC as the material of the slider substrate and at most lower than or equal to that of Al₂O₃ as the material of the thin film stack part.

Preferably, the low Young's modulus layer extends over the whole interface between the slider substrate and the thin film stack part.

Preferably, the low Young's modulus layer is made of a polymer material.

In a preferred embodiment, the thin film stack part includes: a first thermal displacement restriction limiting part as the thermal displacement restriction limiting part containing at least part of the read/write element, the thermal expansion transmitting part and the heating element in the width direction of the magnetic head slider; and a second thermal displacement restriction limiting part arranged to extend in a direction orthogonal to the width direction of the magnetic head slider.

Preferably, the thin film stack part further includes a third thermal displacement restriction limiting part which is arranged orthogonally to the first thermal displacement restriction limiting part and the second thermal displacement restriction limiting part.

Preferably, the void covers the read/write element, the thermal expansion transmitting part and the heating element. The void is provided with one or more thin bridges each filling in the void at a position in the vicinity of the heating element.

Preferably, the void is not open to an area forming an air bearing surface or to the slider's air-bearing surface but is open to the slider's back surface. The void is provided with a thin bridge filling in the void at a position corresponding to the center of the heating element.

Preferably, the first through third thermal displacement restriction limiting parts are implemented by voids. A bridge with a small thickness as a part for filling in the void with a prescribed material is formed between the first and second thermal displacement restriction limiting parts and/or between the second and third thermal displacement restriction limiting parts.

Preferably, the magnetic head slider further comprises one or more second heating elements arranged in parallel with the heating element serving as a first heating element. When two or more second heating elements are provided, the second heating elements are connected in series and driven by the same control power as input power.

In accordance with another aspect of the present invention, there is provided a magnetic disk drive comprising: a magnetic disk on which data are recorded along tracks; a spindle motor for rotating the magnetic disk; a magnetic head slider flying above the rotating magnetic disk and reading and writing data from/to the magnetic disk (the magnetic head slider including a read/write element for executing the reading/writing of data, at least one heating element arranged in a width direction of the magnetic head slider with respect to the read/write element for generating heat in response to energization, a thermal expansion transmitting part lying between the heating element and the read/write element for transmitting thermal expansion caused by the heating of the heating element and thereby displacing the read/write element in the width direction, and a thermal displacement restriction limiting part formed in a region covering at least part of the region of the thermal expansion transmitting part for limiting restriction on the displacement in the width direction by the thermal expansion transmitting part); a heating control circuit including a phase-lead filter with a property inverse to that of the heating element and controlling and driving the heating element; a head support part for supporting the magnetic head slider; a voice coil motor for driving the head support part and thereby moving the magnetic head slider relative to the magnetic disk; a calculation circuit for calculating a position error of the read/write element with respect to the track based on data read out by the read/write element; a coarse movement control circuit for driving the voice coil motor based on the position error of the read/write element; and a fine movement control circuit for energizing the heating element based on the position error of the read/write element.

In a preferred embodiment, the magnetic head slider includes the heating element on each side of the read/write element in regard to a transverse direction. Electric power proportional to a positive value of a position error signal regarding the position error of the read/write element with respect to the track is inputted from the heating control circuit to one heating element. Electric power proportional to a negative value of the position error signal is inputted from the heating control circuit to the other heating element. The read/write element is displaced due to thermal expansion in the vicinity of the energized heating element. Feedback control is conducted so as to minimize position error caused by the displacement.

Preferably, the magnetic head slider includes first and second heating elements on one side of the read/write element in regard to a transverse direction. DC power corresponding to a center position of the positioning of the read/write element is applied by the heating control circuit to the second heating element farther from the read/write element. Electric power proportional to a positive value of a position error signal regarding the position error of the read/write element with respect to the track is inputted from the heating control circuit to the first heating element. Electric power proportional to a negative value of the position error signal is inputted from the heating control circuit to the second heating element. The read/write element is displaced due to thermal expansion in the vicinity of the first and second heating elements. Feedback control is conducted so as to minimize the position error.

By the present invention, thermal expansion can be caused efficiently to the material in the vicinity of the heating element and the thermal expansion from the heating element can be transmitted to the read/write element with high efficiency, by which a displacement of the read/write element necessary for the record track-following positioning control of the read/write element can be caused. In a preferred embodiment, the read/write element can be displaced in the direction corresponding to the track width direction (i.e. width direction of the magnetic head slider) at high speed and with high accuracy within a permissible range of temperature rise, by compensating for a delay in the time response of the heating element by use of a phase-lead compensator having a property inverse to that of the heating element. By employing the well-known proportional-integral control, etc., the positioning of the read/write element to an intended track (target track) with a high frequency control band, with high accuracy and with ease can be realized.

### BRIEF DESCRIPTION OF THE DRAWINGS

FIG. 1 is a schematic diagram showing the configuration of a magnetic head slider in accordance with an embodiment of the present invention.

FIG. 2 is an overall perspective view of the magnetic head slider according to the embodiment.

FIG. 3 is a perspective view of a magnetic disk drive in which the magnetic head slider is installed.

FIGS. 4A-4E are schematic diagrams showing steps in a manufacturing method of the magnetic head slider in accordance with an embodiment.

FIG. 5 is a schematic diagram showing a step in a manufacturing method of a magnetic head slider in accordance with another embodiment.

FIG. 6A is a schematic diagram showing a step in a manufacturing method of a magnetic head slider in accordance with another embodiment.

FIG. 6B is a schematic diagram showing a step in a manufacturing method of a magnetic head slider in accordance with another embodiment.

FIG. 7 is a schematic diagram showing the configuration of a magnetic head slider in accordance with another embodiment.

FIG. 8 is a schematic diagram showing the configuration of a magnetic head slider in accordance with another embodiment.

FIG. 9 is a schematic diagram showing the configuration of a magnetic head slider in accordance with another embodiment.

FIG. 10 is a schematic diagram showing the configuration of a magnetic head slider in accordance with another embodiment.

FIGS. 11A and 11B are schematic diagrams showing the configuration of a magnetic head slider in accordance with another embodiment.

FIGS. 12A and 12B are schematic diagrams showing the configuration of a magnetic head slider in accordance with another embodiment.

FIG. 13 is a schematic diagram showing the configuration of a magnetic head slider in accordance with another embodiment.

FIG. 14 is a schematic diagram showing the configuration of a magnetic head slider in accordance with another embodiment.

FIG. 15 is a schematic diagram showing the configuration of a magnetic head slider in accordance with another embodiment.

FIG. 16 is a block diagram showing track positioning control blocks of a magnetic disk drive in accordance with an embodiment.

FIGS. 17A and 17B are block diagram showing the transfer property of a phase-lead filter and a thermal actuator in accordance with an embodiment.

FIGS. 18A and 18B are graphs showing input-output characteristics of the thermal actuator itself, the phase-lead filter, and the thermal actuator with compensation by the phase-lead filter in accordance with an embodiment.

FIGS. 19A and 19B are graphs showing time response characteristics of the electric power input and the displacement output of the thermal actuator when stepwise input voltage is inputted to the compensation filter (phase-lead filter).

FIG. 20 is a block diagram showing a configuration for track-following feedback control of the thermal actuator.

FIG. 21 is a graph showing a target value response characteristic and a position error characteristic of the thermal actuator when feedback control for compensating for the positioning error is executed by proportional-integral control.

FIG. 22 is a schematic cross-sectional view showing the configuration of a magnetic head slider in accordance with another embodiment.

FIG. 23 is a schematic cross-sectional view showing the configuration of a magnetic head slider in accordance with another embodiment.

FIG. 24 is a schematic cross-sectional view showing the configuration of a magnetic head slider in accordance with another embodiment.

### DESCRIPTION OF THE PREFERRED EMBODIMENTS

Referring now to the drawings, a description will be given in detail of preferred embodiments in accordance with the present invention.

### [Configuration of Magnetic Disk Drive]

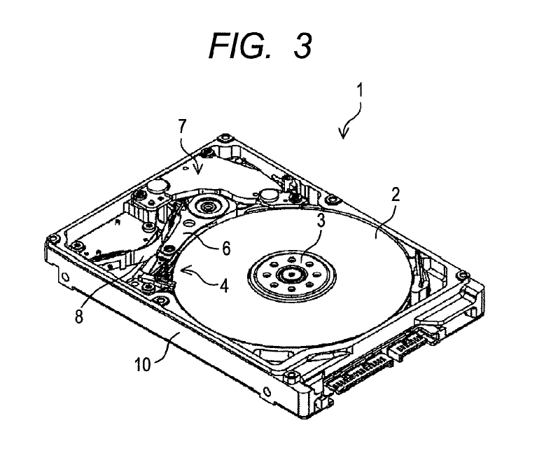

FIG. 3 shows an example of the configuration of a magnetic disk drive employing a magnetic head slider in accordance with the present invention (cover is omitted for illustration). The magnetic disk drive 1 has an enclosure (DE: Disk Enclosure) 10 which houses components such as one or more magnetic disks 2 and head support parts 6. The magnetic disk 2 is attached to a spindle motor 3 functioning as the disk actuator. A plurality of tracks have been formed on the magnetic disk 2 in a pattern of concentric circles and servo data have been written to each track at prescribed periods. The servo data includes address data and a burst signal.

The head support part 6 is supported by a post adjoining the magnetic disk 2, and a magnetic head slider 4 is fixed to the tip of the head support part 6. The magnetic head slider 4, flying over the rotating magnetic disk 2 at a position close to the disk surface by being lifted by air flow, reads and writes data from/to the magnetic disk 2. On the other hand, a voice coil motor 7 as the head actuator is provided at the rear end of the head support part 6. The voice coil motor 7 drives and pivots the head support part 6 and thereby moves the magnetic head slider 4 substantially in the radial direction of the magnetic disk 2. The magnetic head slider 4 and the voice coil motor 7 are electrically connected to a circuit board (unshown) on the back of the enclosure 10 via FPCs (Flexible Printed Circuits) 8 attached to the head support part 6.

### [Thermal Actuator Structure of Magnetic Head Slider]

### Embodiment 1

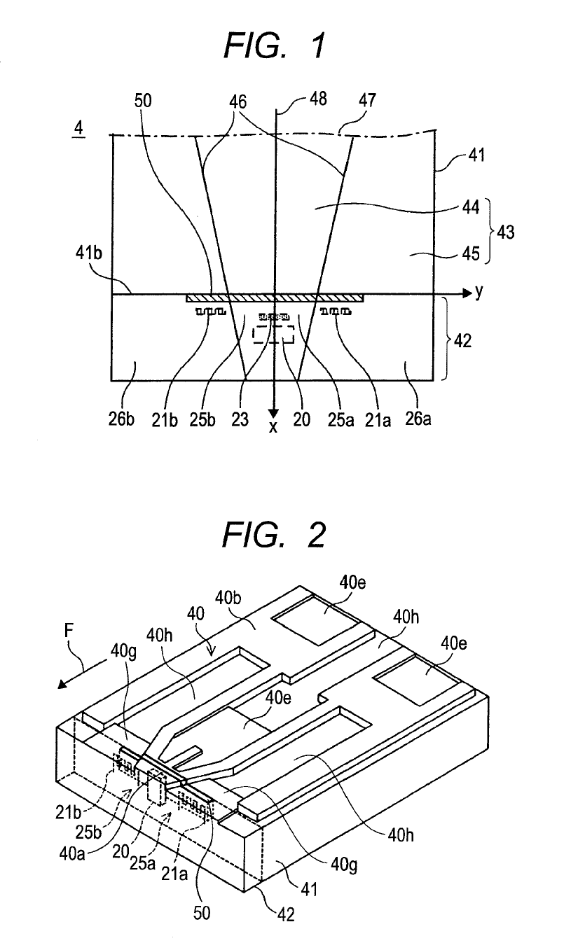

FIG. 1 shows a partial configuration of a magnetic head slider having a thermal actuator structure in accordance with an embodiment of the present invention. FIG. 2 is an overall perspective view of the magnetic head slider. The magnetic head slider 4 includes the slider substrate 41 and the thin film stack part 42 which has been formed on the slider substrate 41 by a thin film formation process. The thin film stack part 42 includes the read/write element 20 (also referred to as a “magnetic head” or a “magnetic transducer”) for reading and writing data from/to the magnetic disk, heating elements 21a and 21b (also referred to collectively as a “heating element 21”), a heating element 23, thermal expansion transmitting parts 25a and 25b (also referred to collectively as a “thermal expansion transmitting part 25”) for transmitting the thermal expansion caused by the heating element 21, and a void 50 of a prescribed depth formed at a position close to the boundary 41b between the slider substrate 41 and the thin film stack part 42. The thermal expansion transmitting part 25 transmits the thermal expansion of the part in the vicinity of the heating element 21 and thereby moves the read/write element 20 in a transverse direction (±y directions) for the positioning of the read/write element 20. Meanwhile, the heating element 23 causes thermal expansion of the surrounding part and thereby makes the read/write element 20 protrude from the gliding face of the magnetic head slider 4 toward the magnetic disk surface (in a z direction). The reference characters “26a” and “26b” represent parts outside the heating elements 21a and 21b, respectively. Here, the “transverse direction” means the width direction of the magnetic head slider having prescribed width and length. In relation to the magnetic disk, the transverse direction means the track width direction of the magnetic disk.

On the gliding face 43 of the magnetic head slider 4, an air bearing surface 44 and groove areas 45 (including shallow grooves and deep grooves) are formed. The reference character “46” represents a step boundary line between the air bearing surface 44 and the groove area 45, “41b” represents the (stack part) boundary 41b between the thin film stack part 42 and the slider substrate 41, “47” represents a section line (imaginary) between a front part (shown in FIG. 1) of the slider substrate 41 and a rear part (unshown), and “48” represents the center line of the head slider (coinciding with the X-axis).

Incidentally, while the read/write element 20, the heating elements 21 and the head protrusion heating element 23 are actually formed not on the gliding face 43 but inside the head slider, the elements 20, 21 and 23 are shown in FIG. 1 (by projecting them on the gliding face) for easy understanding.

For convenience of explanation, in FIG. 1 (and subsequent figures), the origin of the orthogonal coordinate system is set at the intersection of the stack part boundary line 41b and the center line 48 on the air bearing surface 44 of the gliding face 43 of the head slider. The x coordinate axis (positive) is set to extend toward the rear of the head slider, the y coordinate axis (positive) is set to extend to the heating element 21a side, and the z coordinate axis (negative) is set to extend from the gliding face 43 to the inside of the head slider. The thickness of the thin film stack part 42 in the x direction is approximately 60 μm at most, while the width of the head slider in the y direction is as wide as approximately 700 μm (note that the head slider shown in FIG. 1 is extremely extended in its longitudinal direction (x direction)).

The x-axis corresponds to the extending direction of each track formed on the magnetic disk 2, while the y-axis corresponds to the track width direction of the magnetic disk. In the magnetic head slider 4, a central part of the backside surface of the slider substrate 41 (on the −x side of the section line 47, unshown in FIG. 1) is bonded and fixed to a suspension at the tip of the head support part 6. When the heating element 21a is energized and heated, the material in the vicinity of the heating element 21a expands thermally and the thermal expansion displaces the read/write element 20 in the −y direction. The displacement is approximately zero in the central part of the slider substrate 41 and reaches the maximum in a part close to the rear end of the thin film stack part 42. Therefore, the read/write element can be displaced in the −y direction with respect to the slider substrate (i.e., with respect to the head support part) by the energization of the heating element 21a. In contrast, when the heating element 21b is energized, the read/write element is displaced in the +y direction through the same mechanism. By displacing the read/write element in the ±y directions by use of the displacing action of the magnetic head slider (thermal actuator structure), high accuracy positioning to the recording track can be realized.

The property of the head displacement output with respect to the electric power input to the heating element is affected in the first place by the position of the heating element. Assuming that the distance from the origin to the end of the heating element 21a in the x direction is Lx, the distance in the y direction is Ly and the distance in the −z direction (depth inside the thin film stack part from the gliding face) is Lz, a simulation made it clear that the distances Lx, Ly and Lz are desired to be set approximately within the ranges Lx=3-30 μm, Ly=35-70 μm and Lz=20-40 μm. In a case where Lx=3.7 μm, Ly=40 μm and Lz=30 μm, for example, a head displacement of approximately 5 nm in the stationary state is obtained when the electric power input is 50 mW.

When the other heating element 23 is energized, the part in the vicinity of the heating element 23 thermally expands in the y direction and also in the z direction, causing the read/write element surface to protrude. This allows the magnetic head to approach the recording medium surface (magnetic disk surface) for the data reading/writing, enhancing the read/write efficiency and realizing high density recording. Incidentally, while a part of the gliding face in the vicinity of the heating element 21 (for the head positioning) also thermally expands in the z direction, the thermal expansion (protrusion) caused by the heating element 21 has to be prevented from changing the air bearing surface or affecting the flying properties of the magnetic head slider. For this reason, the position of each heating element 21 (for the head positioning thermal actuator) in the x-y plane is set not in the area of the air bearing surface 44 but in the area of the groove area 45. The level difference between the air bearing surface and the groove area is at least 10 nm or more.

Since the skirt of the gliding face's protrusion caused by the energization of the heating element 21 extends over some tens of microns, the surface at the head position is also elevated. Meanwhile, the read/write element 20 is designed to protrude its surface in the read/write operation by use of the heating element 23 and thereby reduce the clearance (distance) between the magnetic disk and the head flying over the magnetic disk. Therefore, the change in the height of the head surface caused by the head positioning heating element 21 has to be at most smaller than the protrusion of the read/write element surface (head surface) caused by the head protrusion heating element 23. Each heating element 21 is placed at least 35 μm apart from the slider's center line 48 (Ly=35-70 μm) for this reason.

As is understandable from the above explanation, a thermal actuator part (including the regions of the heating elements 21, the read/write element 20 and the thermal expansion transmitting parts 25), which is manufactured by a thin film formation process in close contact with the stack part boundary surface 41b of the slider substrate 41, is formed integrally with the slider substrate. Therefore, the displacement of the thermal actuator in the y direction was severely restricted in the conventional magnetic head slider having no void 50 (described in the JP-A-2009-170014).

In contrast, the magnetic head slider 4 in accordance with the present invention is capable of limiting (relaxing) or eliminating the restriction on the displacement in the y direction by providing the void 50 at the position close to the stack part boundary 41b, enhancing the displacement efficiency. The void 50 is a cavity in a shape like a thin rectangular parallelepiped having a prescribed depth (which can also be referred to as a “gap”).

The dimensions of the void 50 are as follows: the thickness in the x direction is desired to be approximately 2-5 μm or less (preferably, open to the gliding face) and the depth in the z direction is desired to be 40 μm or more (preferably, extending to a depth of approximately 120 μm). The length in the y direction is desired to cover at least the read/write element 20 and the heating elements 21a and 21b. In order to enhance the displacement efficiency of the read/write element, the void 50 is desired to extend to positions approximately 5 μm outside the heating elements 21 for the following reason: The region undergoing the temperature rise by each heating element 21 extends to the position approximately 5 μm outside the heating element and the thermal expansion is caused to the material in the region. To eliminate the restriction on the thermal expansion, the void length extending to the positions approximately 5 μm outside the heating elements 21 is desirable. According to a simulation, in a case where the void length in the y direction is set to reach the positions 5 μm outside the heating elements 21, the maximum displacement (or displacement efficiency) of the read/write element in the stationary state is successfully multiplied by 2.8, 4.9, 5.5 and 7.6 when the void depth in the z direction is 40 μm, 60 μm, 80 μm and 112 μm, respectively, compared to the conventional magnetic head slider having no void (described in the JP-A-2009-170014).

Incidentally, the void 50 may also be replaced with a layer formed of a material (e.g., polymer material such as resin) having a low Young's modulus (low Young's modulus layer). The void and the low Young's modulus layer may be collectively referred to as a “low Young's modulus part”, or a “thermal displacement restriction limiting part” or “thermal displacement restriction removing part” from the viewpoint of limiting or removing the restriction on the thermal displacement caused by the heating element. The void 50, capable of setting the Young's modulus of the part at zero, is functionally the most desirable. Since the thermal conductivity of air is as low as approximately 1/1000 of that of Al₂O₃TIC (material of the slider substrate 41) and approximately 1/50 of that of Al₂O₃, the void 50 has the effects of blocking the heat of the heating element 21 from flowing out to the Al₂O₃TiC, enhancing the temperature rise in the vicinity of the heating element, and increasing the thermal expansion efficiency with respect to the electric power input.

Meanwhile, the low Young's modulus part 5 (the void 50 or the low Young's modulus layer) reduces also the restriction on the thin film stack part in the direction toward the gliding face, and thus the low Young's modulus part 5 enhances the thermal expansion protrusion of the air-bearing surface in the vicinity of the heating element. Therefore, when the gliding face's protrusion in the vicinity of the read/write element caused by the thermal actuator should be suppressed, the low Young's modulus part 5 is desired not to be extended to the outside of the heating elements 21 but to be kept approximately within a range between the centers of the heating elements 21. A design keeping the low Young's modulus part 5 within a range between the inner ends (on the read/write element's side) of the heating elements 21 is also recommendable. Even in this case, the displacement efficiency of the read/write element can be increased considerably compared to the conventional magnetic head slider since the region of the thermal expansion transmitting parts 25 and the heating element 23 is still not restricted. The length of the low Young's modulus part 5 in the y direction in the present invention is not restricted to the example shown in FIG. 1 since the gliding face's protrusion at the position of the read/write element caused by the thermal actuator's heating element varies depending on the design conditions of the air bearing surface.

### [Manufacturing Process of Magnetic Head Slider]

### Embodiment 2

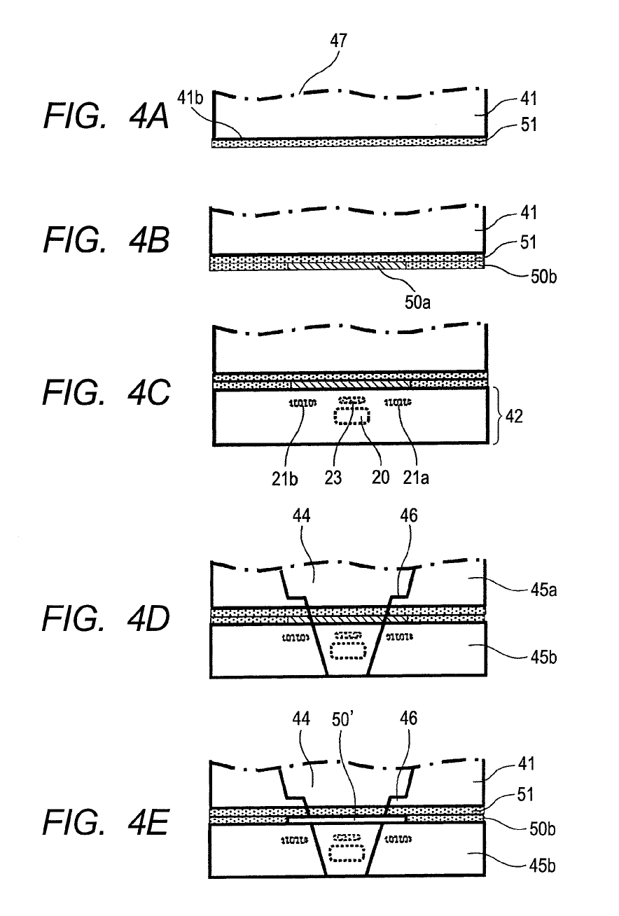

The manufacturing method of the magnetic head slider having the void 50 will be explained below referring to FIGS. 4A through 4E. The void 50 is formed in the thin film formation process of forming the thin film stack part 42 (including the read/write element 20 and the heating element 23) on the slider substrate 41.

First, as shown in FIG. 4A, a film 51 of alumina (Al₂O₃) is formed on the boundary surface 41b of the slider substrate 41 made of Al₂O₃TiC. The thickness of the film 51 may be set arbitrarily (approximately 0.1-1.0 μm). Subsequently, as shown in FIG. 4B, a layer 50a of metal soluble in an alumina alkaline solution (e.g., Cu) and an alumina layer 50b are formed on the film 51. The copper layer 50a and the alumina layer 50b are of the same thickness. The copper layer 50a is formed in the same dimensions (width (length), thickness, depth) as the intended void 50, while the alumina layer 50b is formed to cover the boundary surface 41b of the slider substrate except the copper layer 50a. The depth of the copper layer (from the sheet of FIG. 4B) is approximately 40-120 μm. The width (length) of the copper layer in the transverse direction extends to the positions approximately 5 μm outside the heating elements 21 at most. The minimum width (length) of the copper layer approximately coincides with the range between the inner ends (on the head's side) of the heating elements 21. FIG. 4B shows a case where the width (length) of the copper layer substantially coincides with a range between the outer ends of the heating elements 21. The thickness of this layer is set at 0.1-3 μm. While the thicknesses of the copper layer 50a and the alumina layer 50b, formed in different steps, do not necessarily coincide with each other, the thicknesses of the two layers have to be equalized for the subsequent formation steps. Therefore, processing for flattening the layers 50a and 50b is carried out when necessary after the formation of the layers.

Subsequently, as shown in FIG. 4C, the thin film stack part 42 including the read/write element 20, the head positioning heating elements 21a and 21b and the head protrusion heating element 23 is formed by a thin film process. The formation of the thin film stack part 42 including these elements can be implemented by use of already-known materials and process. Subsequently, as shown in FIG. 4D, the air bearing surface 44 and the groove areas 45a and 45b are formed on the gliding face of the magnetic head slider 4. The reference character “46” represents the boundary lines of the air bearing surface 44. The shape of the air bearing surface can be designed by use of an existing simulation technique under the condition that the head positioning heating elements 21a and 21b are placed in the areas of the groove areas 45a and 45b. The groove areas 45a and 45b can be formed by removing corresponding parts of the slider member by an etching technique. Subsequently, as shown in FIG. 4E, the void 50 is formed by removing the copper layer 50a by immersing the slider member in the alkaline solution. The step for removing the copper layer 50a and the step for forming the air bearing surface 44 may be executed in reverse order. The solution/removal of the copper layer 50a is possible even when the depth of the copper layer to be removed exceeds 100 μm. Incidentally, in this case of FIGS. 4A-4E where the length of the void 50 extends to the positions of the outer ends of the heating elements, the air bearing surface 44 is separated by the void 50 and thus the pressure generated on the air bearing surface terminates at the position of the void 50. Therefore, the shape of the air bearing surface is designed taking this into consideration.

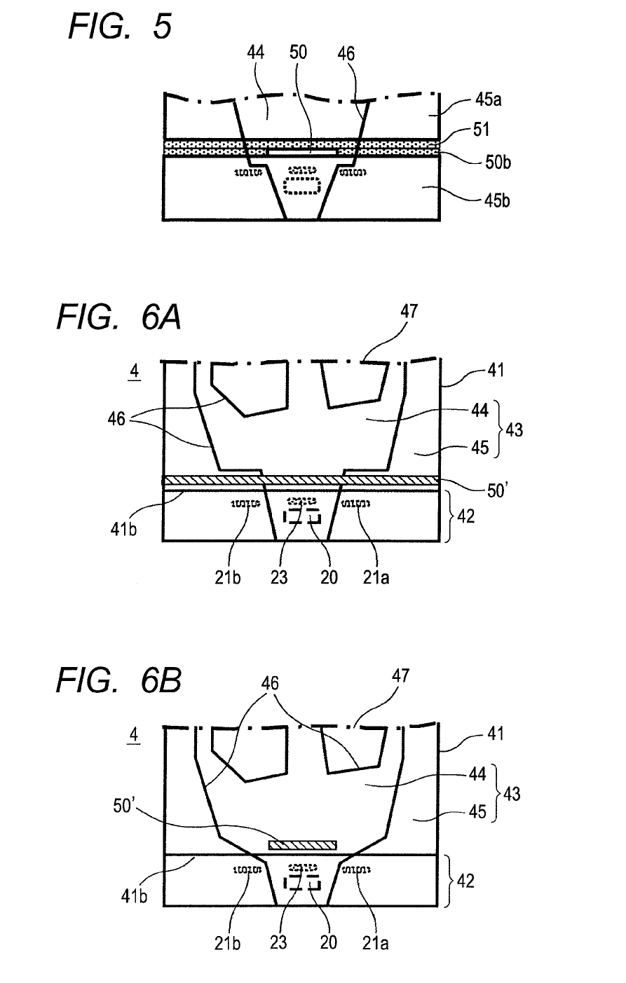

FIG. 5 shows a modification of the above embodiment. In this example, the width (length) of the void 50 is reduced so that the void fits in the air bearing surface 44. The method of forming the void 50 in FIG. 5 is substantially identical with that shown in FIGS. 4A-4E. In this example, the air bearing pressure is not let out to the atmosphere by the void 50. Therefore, high pressure can be generated and maintained to the rear end of the head slider and the rigidity of the air film in the vicinity of the read/write element can be increased, while also providing the air bearing with an effect of enhancing the vibration damping. Although the head transverse displacement efficiency decreases a little, the example of FIG. 5 with the narrow void 50 has an advantage in that the air bearing surface can be designed simply by regarding the void 50 not as a void but as a groove enhancing the vibration damping.

A modification of the method of forming the void 50 is also possible. For example, the void 50 can be formed not in the thin film formation process for forming the thin film stack part 42 but after the formation of the thin film stack part including the heating elements, by creating (digging) a groove (void) from the gliding face of the magnetic head slider by executing a machining process or laser beam processing before or after the etching process is conducted to the gliding face. The machining process can be implemented by using, for example, a dicing saw which is generally used for cutting (dicing) silicon wafers, etc. In this case, the minimum value of the thickness of the rotating grinder saw is 25 μm.

FIG. 6A shows an example of the processing for forming the groove 50′ by using the dicing saw. In the case where the machining process is started from the gliding face 43 of the slider, the groove 50′ is formed at a position at least some microns inside the Al₂O₃TiC material (slider substrate 41) from the slider substrate's boundary 41b in order to prevent the read/write element 20 from being affected by the processing stress. When a dicing saw with a thickness of 25 μm is used for the processing, the width of the groove amounts to approximately 40 μm at the maximum due to vibration. Although the designing of the air bearing surface considering the width of the groove 50′ is necessary similarly to the example of FIGS. 4A-4E, an air bearing surface having satisfactory trackability can be formed also in this example. The groove can be formed to a depth of approximately 80 μm. In the case where a dicing saw is used for the processing for forming the groove 50′, a groove across the whole width (in the transverse direction) of the slider surface is formed since the processing is generally conducted to a block including a plurality of magnetic head sliders formed on a common slider substrate (before being cut into pieces). Even in this case, the heat blocking effect and the limitation/removal of the mechanical restriction on the thermal actuator part from the slider substrate can be expected from the aforementioned principles, by which the displacement efficiency of the thermal actuator can be increased. The present invention also includes this type of modifications deriving from restrictions on the technology for forming the void. The design of the air bearing surface in this example is substantially identical with that in the example of FIGS. 4A-4E since the effect of the groove 50′ (formed by the processing) on the air bearing function of the groove areas 45 is negligibly small.

FIG. 6B shows an example in which the groove is formed (dug) from the gliding face 43 of the slider by the laser beam processing. In this case, the groove 50′ can be fit in (formed within) the air bearing surface 44 similarly to the example of FIG. 5. The width of the groove 50′ can arbitrarily be selected and adjusted by changing and adjusting the position of the laser beam irradiation.

### [Example Using Low Young's Modulus Material]

### Embodiment 3

It is also possible to form a low Young's modulus layer 500 by, for example, filling the groove 50′ (or void 50) formed by the laser beam processing (in a shape selected from the examples of FIGS. 4A-4E, FIG. 5, FIG. 6A and FIG. 6B) with a material having a low Young's modulus (e.g., polymer material such as resin). Since the Young's modulus of the polymer material is as low as approximately 1/100 of that of Al₂O₃TIC and approximately 1/50 of that of Al₂O₃, the displacement efficiency of the thermal actuator is multiplied by approximately 2.2 compared to a magnetic head slider with no groove (filled with Al₂O₃) when the thickness of the low Young's modulus layer 500 is approximately 3 μm. Still higher displacement efficiency can be achieved by increasing the thickness ten times. In this example employing the low Young's modulus layer 500, the effect of the air bearing of the void 50 on the magnetic head slider's flying properties can be eliminated even when the width of the void 50 (low Young's modulus layer 500) is increased.

### [Modification of Groove 50′]

### Embodiment 4-1

Several modifications are possible regarding the void 50 formed in a part of the thin film stack part 42 in the vicinity of the boundary 41b of the slider substrate 41. For example, a part of the void 50 from the gliding face 43 to some microns from the gliding face can be filled in with Al₂O₃, without letting the void 50 be open to the gliding face. In this case, however, the displacement efficiency of the thermal actuator deteriorates since the mechanical restriction of Al₂O₃ on the thermal actuator's displacement increases. For example, even when the void 50 is as deep as 112 μm (Sz=112 μm), the multiplying factor of the displacement efficiency remains no more than 2.6 if a part of the void from the gliding face to 10 μm (in the z direction) from the gliding face is replaced and filled in with Al₂O₃. However, the protrusion toward the gliding face caused by the thermal expansion in the vicinity of the heating element can be also suppressed by the filling with Al₂O₃.

Even in this case, the heat blocking effect and the limitation/removal of the slider substrate's mechanical restriction on the thermal actuator part can be expected from the aforementioned principles, by which the displacement efficiency of the thermal actuator can be enhanced. The present invention also includes this type of modifications deriving from restrictions on the technology for forming the void 50.

In spite of the deterioration in the thermal actuator's displacement efficiency, the design forming no opening of the void at the gliding face has advantages in that it requires no alteration to the conventional design conditions of the air bearing surface and it is highly compatible with the lubricant and the flying properties of the slider. Therefore, it is possible to devise some embodiments as examples forming no groove at the gliding face while successfully reducing the deterioration in the head transverse displacement efficiency of the thermal actuator as much as possible.

### [Modification of Void 50]

### Embodiment 4-2

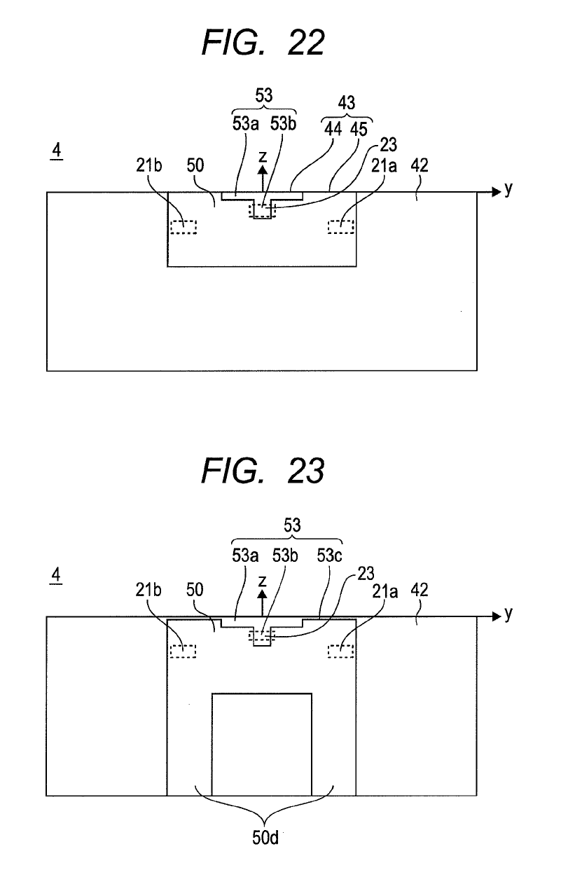

FIG. 22 shows a y−z cross section of an example of a magnetic head slider in which the void is not opened to the air bearing surface 44 in the vicinity of the head but is opened to only the groove area 45 of gliding surface. The reference character “42” in FIG. 22 represents the cross section of the thin film stack part (generally made of Al₂O₃). The heating element 23 for the air bearing surface protrusion control (TFC) and the heating elements 21a and 21b for the head positioning are indicated with broken lines since the elements do not actually exist on the cross section. The characteristic of this example is that the central part of the void is filled in with a nonconductive hard ceramics material (e.g., alumina) in a T-shape, that is, the void has a T-shaped shielding bridge 53. The T-shaped shielding bridge extending in the y direction is made up of three parts: a central part 53b extending in the −z direction and two lateral parts 53a with a small thickness in the z direction. Since the top surface of each lateral part 53a serves as the air bearing surface 44, the length of each lateral part 53a in the y direction is set so that the total length of the shielding bridge 53 in the y direction becomes slightly greater than the width of the air bearing. The thickness of the bridge 53 (lateral parts 53a) in the z direction is desired to be as small as possible (2-5 μm) so as not to restrict the y-direction head transverse displacement caused by the heating element. On the other hand, the central part 53b is designed mainly to increase the cooling effect by efficiently conducting the heat generated by the heating element 23 (used for thermally expanding the head surface in the direction orthogonal to the gliding face) to the slider substrate, reduce the temperature rise of the read/write element, and enhance the responsiveness of the head flying clearance control by the heating element 23. Therefore, the central part 53b extends in the −z direction approximately to the lower end position of the heating element 23 used for the protrusion control (TFC). However, the width of the central part 53b is desired to be narrower than that of the protrusion control heating element 23 since setting the width at that of the heating element 23 or wider leads to excessive restriction on the transverse displacement of the read/write element. According to a numerical simulation, the y-direction displacement efficiency of the read/write element by the heating element 21a can be increased to twice or more of that of the magnetic head slider with no void 50. Incidentally, it is obvious that the T-shaped bridge 53 can be formed with ease in the aforementioned thin film stacking process (thin film formation process), by forming the alumina layer also in the (T-shaped) central part while the alumina layer is formed in part (partial area) of the thin film stack part 42 as shown in FIG. 22. The bridge 53 also has the function of increasing the coupling strength between the thin film stack part and the slider substrate. In order to enhance the function, the central part 53b of the T-shaped shielding bridge 53 shown in FIG. 22 may be narrowed further and extended further in the −z direction to be connected with the alumina member, separating the void 50 into two regions. In this case, the width of the central part 53b extending downward from the center of the bridge 53 is desired to be as narrow as possible (e.g., approximately 2-3 μm or less) so as not to restrict the head transverse displacement by the thermal actuator.

### [Modification of Void 50]

### Embodiment 4-3

FIG. 23 shows an example of a shielding bridge which eliminates the opening of the void 50 to the shallow groove area. In this example, bridges 53c made of alumina, etc.

are added to the T-shaped shielding bridge 53 described in the above embodiment 4-2 (FIG. 22). While an example of a shielding bridge having a thickness of 10 μm in the z direction from the gliding face has been described in the embodiment 4-1, this embodiment 4-3 is an example with a void structure not open to the gliding face 43, satisfying the condition of not negatively affecting the design conditions of the air bearing surface, the bearing surface protrusion control by the TFC heating element 23 or the temperature rise of the read/write element, while also being capable of increasing the transverse displacement of the read/write element caused by the heating element 21. This example, in which the void 50 is not open even to the shallow groove area of the gliding face, has an advantage in that there is no danger that the lubricant adhering to the head slider enters and remains in the void.

The embodiment 4-3 shown in FIG. 23 is further provided with two voids 50d extending toward the back of the slider (opposite to the gliding face) differently from the embodiment 4-2 of FIG. 22. The voids 50d are solvent inlet channels used for dissolving and removing copper (formed in the void part in the thin film stacking process) after the formation of the entire thin film stack part 42. The voids 50d are also used as discharging channels for discharging the dissolved copper. While the solvent is injected from the air bearing surface in the embodiment 4-2, this embodiment 4-3 enables the injection of the solvent from the back surface of the slider, facilitating a shielding process for preventing the read/write element part from being eroded by the solvent. In order to minimize the deterioration in the displacement efficiency of the read/write element 20 by the heating elements 21a and 21b, the thickness of the bridges 53c in the z direction is desired to be small (0.5-2 μm based on the processing conditions). According to a numerical simulation conducted by the present inventors, when the thickness of the void in the x direction is 1 μm, approximately twice the displacement efficiency of the thermal actuator with no void is achieved in a case where the lengths (depths) of the bridges 53a, 53b and 53c in the z direction are 3 μm, 25 μm and 1 μm, respectively and the widths (lengths) of the bridges 53a, 53b and 53c in the y direction are 65 μm, 18 μm and 194 μm, respectively.

In the embodiment 4-2 (having the T-shaped bridge in the central part) and the embodiment 4-3 (eliminating the opening of the slit (void) to the gliding face by forming shallow shielding bridges also in the groove areas), the head transverse displacement efficiency of the thermal actuator slightly deteriorates compared to the open structure and the protruding effect in the vicinity of the head (protrusion of the gliding face) caused by the heating by the heating element 21a, 21b also increases. Further, since the protrusion of the head part by the head protrusion heating element 23 is suppressed by the T-shaped bridge formed in the central part and the protruding effect tends to extend over a larger area, the peak position (where the gliding face's protrusion in the z direction is the maximum) can deviate from the part in the vicinity of the head and approach an edge of the bearing surface on the heating element's side. To prevent this deviation, the distance Ly from the center line (head) to each heating element 21a, 21b in the y direction is desired to be long (e.g., approximately 80 μm-150 μm). By this setting, the z-direction protrusion of the head part by the heating element 21 can be reduced to a fraction of that by the heating element 23. Since the change in the head flying clearance due to the gliding face's protrusion is far smaller than the protrusion of the bearing surface in the vicinity of the head, interference of the control operation of the head positioning thermal actuator with the flying height control by the heating element 23 can be prevented.

While increasing Ly has the effect of enhancing the head transverse displacement efficiency of the heating element 21, the thickness of the void 50 in the x direction may also be increased in order to further enhance the head displacement efficiency. While the thickness of the void 50 was 1 μm in all of the above examples of the head displacement efficiency, the head displacement efficiency can be multiplied by 1.5 by increasing the void thickness to 2 μm.

### [Another Example of Thermal Actuator Structure of Magnetic Head Slider]

### Embodiment 5

The magnetic head slider according to the aforementioned embodiment 1 is applied to a dual-side thermal driving microactuator in which the heating elements 21 are placed on both sides of the read/write element 20 as shown in FIGS. 1 and 2. The dual-side thermal driving microactuator needs no bias power. When electric power is inputted to one of the heating elements 21, the microactuator displaces the head in the direction opposite to the energized heating element 21. In this case, the thermal expansion caused by the heating element to the slider's gliding face can be reduced since it is possible to exclusively/selectively input a particular frequency component (in a high-frequency band to be controlled) to the heating element.

According to another example, the above embodiments can also be applied to a magnetic head slider having a single-side driving thermal actuator part in which the heating element 21 (e.g., 21a) is arranged on only one side of the read/write element 20. In this case, the groove 50′ or the low Young's modulus layer 500 may be formed to cover the range of the heating element 21a placed on one side. The single-side driving thermal actuator needs bias power for positioning (displacing) the read/write element at (to) the center position of the displacement. The head is precisely positioned at the intended position to the right or left of the intermediate position by decreasing or increasing the electric power (supplied to the heating element 21a) from the bias power.

### [Another Example of Thermal Actuator Structure of Magnetic Head Slider]

### Embodiment 6

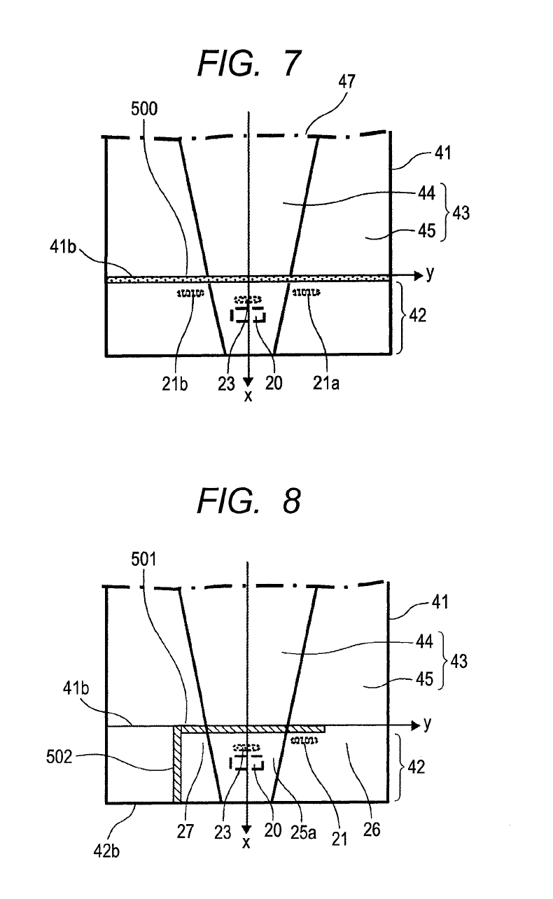

FIG. 7 shows an example of a magnetic head slider in which the low Young's modulus layer 500 (made of a material having a low Young's modulus) is formed on the entire boundary 41b of the slider body (slider substrate 41) with the thin film formation layer (thin film stack part 42). For example, by setting the thickness of the low Young's modulus layer 500 (formed of polymer material such as resin) at 1, 3 and 10 μm, the thermal actuator's displacement efficiency is improved to 1.5, 2.3 and 3.1 times that of the thermal actuator with no low Young's modulus layer 500. In this case, the heating elements 21a and 21b are very close to the boundary 41b of the slider substrate (x-direction distance Lx=3.7 μm), and thus the slider substrate's restriction on the thermal expansion in the vicinity of the heating element 21 and on the thermal actuator's displacement is presumed to be considerably strong if the low Young's modulus layer 500 is absent. Further, since the thermal conductivity of Al₂O₃TiC is 20 times that of Al₂O₃, an increase in thermal expansion efficiency caused by the temperature rise also contributes to the enhancement of the displacement efficiency if a low Young's modulus layer 500 with half the thermal conductivity of Al₂O₃ exists at the boundary.

In the above case where Lx=3.7 μm, the displacement efficiency multiplied 3.1 fold when an Al₂O₃ layer 22 μm thick was laid between the low Young's modulus layer 500 and the Al₂O₃TiC material (slider substrate 41) in order to relax the restriction by the slider substrate. The increase in the displacement efficiency can be understood as a result of an increase in the thermal expansion (due to enhancement of the temperature rise in the vicinity of the heating element) and the relaxation of the mechanical restriction on the thermal actuator since the Young's modulus of Al₂O₃ is approximately half of that of Al₂O₃TiC and the thermal conductivity of Al₂O₃ is also lower ( 1/20) than that of Al₂O₃TiC. This corresponds to a case where Lx=25.7 μm. Even though this example can not be regarded as adding a new material layer, this example may be considered to be within the scope of this embodiment 6 in the sense that a layer of a material having a lower Young's modulus and also having lower thermal conductivity compared to Al₂O₃TiC is introduced.

In short, the embodiment 6 can be regarded generally as a magnetic head slider in which a layer of a material having a Young's modulus lower than that of the slider substrate 41 (at most lower than or equal to that of Al₂O₃) and preferably having thermal conductivity lower than that of the slider substrate 41 (at most lower than or equal to that of Al₂O₃) is formed on the entire boundary 41b with the slider substrate.

### [Another Example of Thermal Actuator Structure of Magnetic Head Slider]

### Embodiment 7

FIG. 8 shows an example of a magnetic head slider in which the heating element 21 for the head positioning thermal actuator is placed on one side. In this example, the magnetic head slider having the single-side driving thermal actuator part is provided with a void 501 formed in the width direction of the slider and a void 502 formed in a part to the left of the read/write element 20 across the whole thickness of the thin film stack part 42. The voids 501 and 502 intersect with each other orthogonally to form an L-shape. Similarly to the embodiment 1, the void 501, 502 is open to the gliding face. The depth of the void may be set arbitrarily (preferably, 40-120 μm from the gliding face).

While the length of the void 501 in the y direction is substantially symmetrical with respect to the x-axis in the example shown in FIG. 8, the y-direction length of the region 27 opposite to the heating element 21 may be set arbitrarily (desired to be shorter). In the magnetic head slider, terminals to be used for energizing the read/write element 20, the heating element 21 (for the head positioning thermal actuator) and the heating element 23 (for protruding the read/write element) are arranged on a rear end face 42b of the thin film stack part 42, and lead wires for connecting the terminals to the elements are formed inside the thin film stack part 42 as thin films. Thus, the void 502 has to be arranged at a position not interfering with the terminals and the lead wires. Under this condition, the void 502 is desired to be arranged as close to the read/write element 20 as possible.

The magnetic head slider of the embodiment 7 is capable of further increasing the heating element's displacement efficiency by 16% to 40% compared to the embodiment 1 since the y-direction displacements of the thermal expansion transmitting part 25a, the read/write element 20 and the region 27 are less restricted compared to the embodiment 1.

### [Another Example of Thermal Actuator Structure of Magnetic Head Slider]

### Embodiment 8

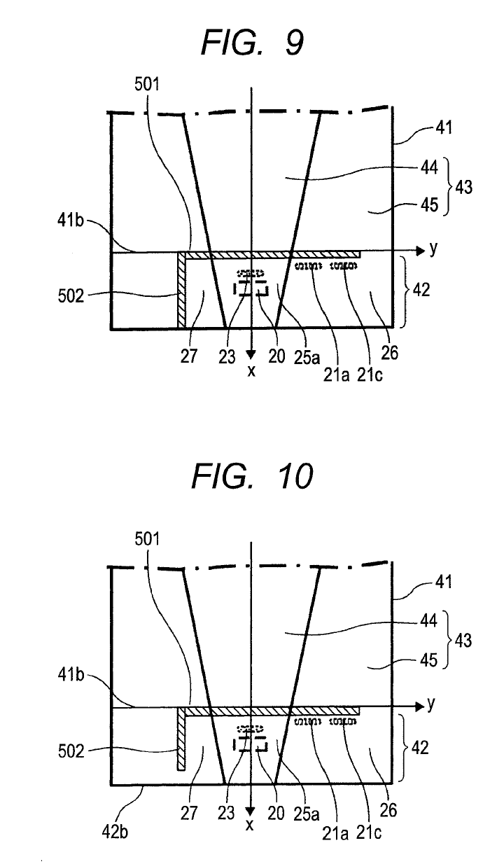

FIG. 9 shows an example of the structure of a magnetic head slider having a single-side driving thermal actuator part in which two heating elements 21a and 21c are arranged in y direction on one side of the read/write element 20. In the magnetic head slider having the L-shaped void in the above embodiment 7, the head positioning control has to be carried out with only one heating element. Thus, the bias power for position the head at the displacement center position has to be applied constantly to the heating element. Protrusion of the read/write element's surface caused by the stationary bias power considerably interferes with the flying height control, etc. This embodiment 8, arranging two heating elements 21a and 21c in y direction on one side of the read/write element, resolves this problem while also taking advantage of the L-shaped void's effect of removing the restriction on the thermal actuator.

In the embodiment 8, the stationary bias power, which determines the average position of the read/write element 20 in the displacement control, is applied to the heating element 21c far from the read/write element. Further, electric power for the variable displacement for the track-following control is applied to the heating element 21c as the difference from the bias power. Meanwhile, the variable displacement of the head in the −y direction is controlled by input power to the heating element 21a close to the read/write element. With this configuration, the protrusion of the gliding face of the read/write element caused by the bias power applied to the heating element 21c can be reduced remarkably while achieving high displacement efficiency of the head positioning thermal actuator.

FIG. 10 shows a modification of the head positioning thermal actuator with the L-shaped void shown (FIG. 9). In this example, the void 502 is formed not across the whole thickness of the thin film stack part 42. A region close to the rear end face 42b is filled in with a stack of films in consideration of the aforementioned condition that numbers of terminals have to be formed at the rear end face 42b. The structure of the L-shaped void 502 according to this example is applicable also to the single-side driving thermal actuator with one heating element 21 described in the embodiment 7 (FIG. 8).

As another modification, part or all of the L-shaped void (501, 502) of the magnetic head slider described in the embodiment 7 or 8 (FIG. 8, 9 or 10) may be filled in with a material having a low Young's modulus or with a material having a low Young's modulus and lower thermal conductivity than Al₂O₃ as explained in the embodiment 3. In this case, however, the head displacement efficiency deteriorates compared to the case where the L-shaped void is not filled in. The widths of the voids 501 and 502 (in directions orthogonal to their lengths) may be different from each other (the same goes for the depths in the z direction). The void 501 may also be formed inside the material of the slider substrate or formed to straddle the boundary between the slider substrate and the thin film stack part due to restrictions on the processing method for forming the void, since all these configurations bring about substantially identical functions and effects. The void 501 may also be formed across the whole width of the slider especially when the void 501 is formed (dug) from the gliding face by machining or laser beam machining. Further, the L-shaped void may also be not open to the gliding face, with the thin film stack part and the slider substrate connected to each other in the region in the vicinity of the gliding face.

### [Another Example of Thermal Actuator Structure of Magnetic Head Slider]

### Embodiment 9

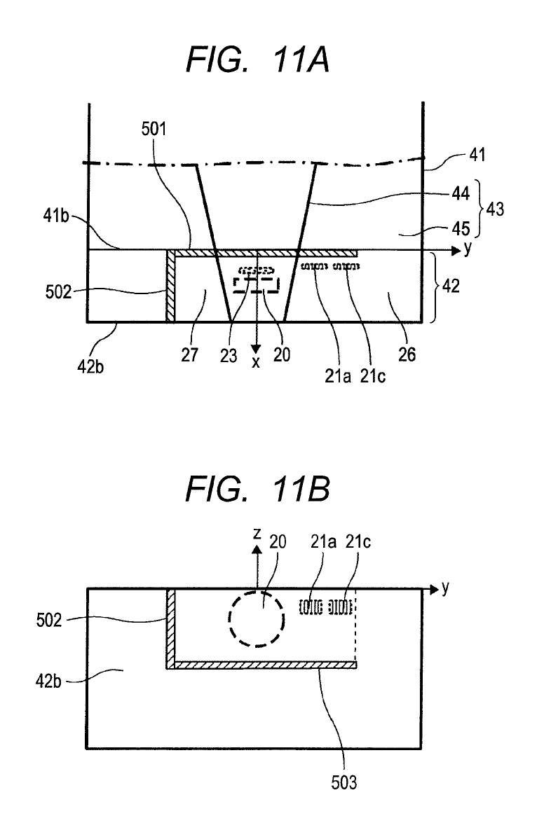

FIGS. 11A and 11B show an example of a thermal actuator having three voids that are orthogonal to the x-axis, y-axis and z-axis, respectively. In this example, in order to further increase the displacement efficiency of the single-side driving head positioning thermal actuator, a void 503 which is in orthogonal to the X-Y plane and open to the rear end face 42b of the magnetic head slider is arranged at a position below the read/write element in the z direction (at a smaller z coordinate compared to the read/write element) in addition to the L-shaped void described in the embodiments 7 and 8. FIG. 11A is a projection view of the magnetic head slider viewing the slider through the gliding face, while FIG. 11B is a projection view of the slider viewing the slider through the rear end face 42b. In order to increase the displacement efficiency, the void 503 is desired to be connected with the voids 501 and 502. In this embodiment, the head positioning thermal actuator part is separated from the slider substrate 41 and the thin film stack part 42 and held in the cantilever style. The entire thermal actuator is linked to the thin film stack part and the slider substrate only via a region 26 outside the heating elements 21a and 21c.

In this embodiment 9, a simulation has predicted that y-direction displacement of the read/write element amounts to 91 nm for an 50 mW input when the length of the void 501 is symmetrical with respect to the x-axis, the void 502 reaches the rear end face 42b of the thin film stack part and the position of the void 503 in the z direction is 112 μm below the gliding face. This is 18 times the displacement efficiency of the thermal actuator of the conventional magnetic head slider.

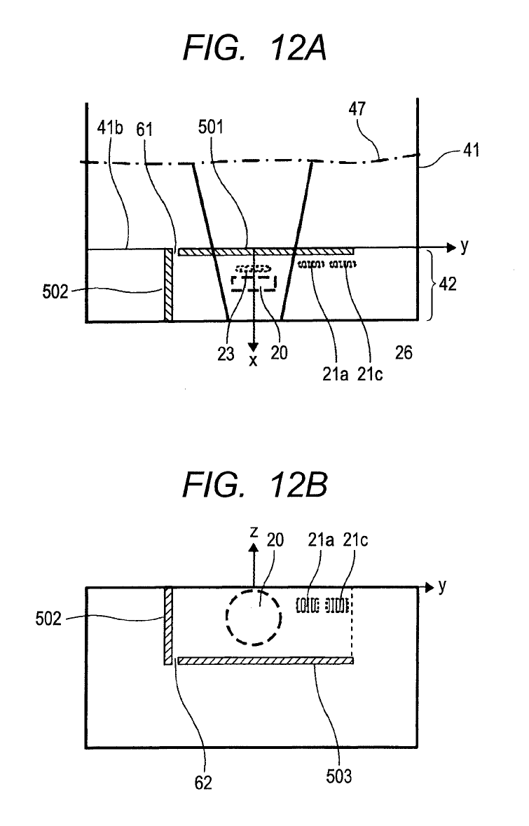

FIGS. 12A and 12B show a modification of the structure shown in FIGS. 11A and 11B. In this structure, the strength of the cantilever-type thermal actuator of FIGS. 11A and 11B (with the voids 501, 502 and 503) is increased without substantially deteriorating the head displacement efficiency, by employing a bridge structure (a part where the void is filled in). As mentioned above, the head displacement efficiency can be multiplied by 18 by forming the voids 501, 502 and 503 surrounding the whole thermal actuator structure so that the entire thermal actuator is held in the cantilever style. However, this structure involves the danger of being broken by external force since the thermal actuator part is linked to the slider body only via the region to the right of the heating elements 21a and 21c.

Therefore, the modification shown in FIGS. 12A and 12B employs a bridge 61 (extending in the z direction) formed at the boundary between the left end of the void 501 and the void 502 and a bridge 62 (extending in the x direction) formed at the boundary between the lower end of the void 502 and the void 503. The length of each bridge 61, 62 (in its extending direction) is desired to be the same as that of the void. The thickness of each bridge (61, 62) in the y direction is desired to be less than the width of the void. By providing the bridges 61 and 62 as above, the mechanical strength of the thermal actuator structure can be increased and the protrusion toward the gliding face caused by the heating elements can be suppressed without substantially deteriorating the head displacement efficiency of the thermal actuator.

As another modification of the embodiment 9, the aforementioned structure having three voids is applicable also to a single-side driving thermal actuator having only one heating element 21 like the one shown in FIG. 8. Incidentally, the voids do not necessarily have to have the same widths, nor do have to be connected with each other at all positions on a ridge line where two void planes (each containing a void) intersect with each other. Part or all of each void may be filled in with a low Young's modulus material.

### [Another Example of Thermal Actuator Structure of Magnetic Head Slider]

### Embodiment 10-1

In this structural example, the restriction on the head displacement is removed/relaxed while suppressing the protrusion toward the gliding face, by forming bridges (parts filled in with a material) in the void 50. In each of the above embodiments, the thermal actuator's displacement efficiency is improved by removing/relaxing the restriction on the thermal expansion displacement of the thermal actuator in the y direction. The structural examples employing a low Young's modulus material have also a heat insulation effect of preventing the heat (generated by the heating element) from leaking to the slider substrate 41 since the thermal conductivity of the low Young's modulus material is in many cases lower than that of the slider substrate (Al₂O₃TiC). By the promotion of the temperature rise, the thermal expansion in the vicinity of the heating element is enhanced, thereby increasing the displacement efficiency with respect to the input power. However, the heat insulation effect is valid only in the vicinity of the heating element. Therefore, the low Young's modulus part 5 formed in a region not in the vicinity of the heating element serves for the increase in the thermal actuator's displacement efficiency by reducing the mechanical restriction on the thermal expansion transmitting parts and the read/write element (and also the mechanical restriction on the region on the side opposite to the heating element).

While the embodiments 1-9 and their modifications described above have the effect of increasing the displacement efficiency of the head positioning thermal actuator, they also increases the gliding face's protrusion in the vicinity of the heating element. However, the effect of the gliding face's protrusion in the vicinity of the heating element on the flying properties of the magnetic head slider can be suppressed to a negligible level since the area in the vicinity of the heating element is not in the air bearing surface but in the shallow groove area as mentioned above. However, the gliding face's protrusion, extending over a considerably large area, can cause variations in the clearance between the head and the magnetic disk surface. Therefore, a structure capable of minimizing the protrusion toward the gliding face while also increasing the displacement efficiency of the head positioning thermal actuator is being requested.

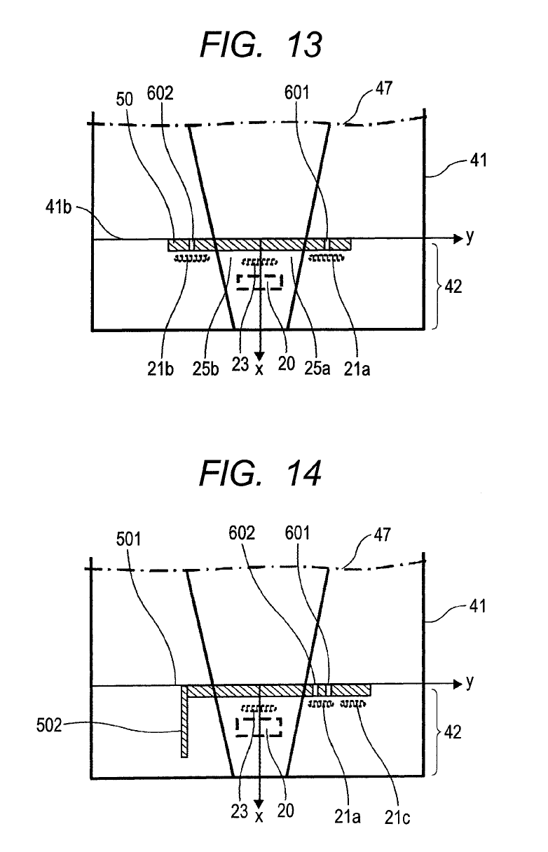

In an example shown in FIG. 13, narrow bridges (parts filled in with a material) 601 and 602 (hereinafter collectively referred to as “bridges 60”) are formed in the void 50 of the magnetic head slider in the embodiment 1 at positions corresponding to the heating elements 21a and 21b, respectively. Each bridge 60 extends in the depth direction of the void (−z direction). The bridge 60 may be of the same length (depth) as the void or extend in the −z direction at least from the gliding face approximately to the lower end of the heating element. While the bridge is desired to be made of Al₂O₃ (material of the thin film stack part 42), it may also be made of Al₂O₃TiC or a different material. However, the bridge's thickness in the y direction is sufficiently small and the sum of the y-direction thicknesses of all the bridges is within several % of the length of the void in the y direction.

As above, the narrow bridges 60 formed in parts of the void do not substantially restrict the y-direction displacement of the thermal actuator. Meanwhile, the bridges, which are thick in the direction to the gliding face, are capable of suppressing the protrusion toward the gliding face in the vicinity of the heating elements (where the bridges are formed), by which the gliding face's protrusion in the vicinity of the head can be suppressed remarkably.

Incidentally, in order not to substantially restrict the y-direction displacement of the thermal actuator even when a plurality of bridges 60 are formed in the void 50, the width of the void (in the x direction) is desired to be greater (several μm-approximately 10 μm) compared to the embodiment 1 and the width (thickness) of the bridge (in the y direction) is desired to be small. For example, in the case where two bridges 601 and 602 of Al₂O₃ are formed in the void 50 as shown in FIG. 13, the dimensions of each bridge when the restricting force against the thermal actuator's y-direction displacement is equivalent to that in a case where the void is filled in with the polymer material described in the embodiment 3 (having a Young's modulus 2% of that of Al₂O₃) are obtained as follows: Assuming that the length of each bridge (in the z direction) is half the depth 80 μm of the void and the length of the void in the y direction is 160 μm, the thickness of each bridge is 1.7, 2.5, 3.4 and 3.9 μm when the width of the void is 3, 5, 8 and 10 μm. The rigidity of each bridge (supporting the thermal actuator) in the y direction is proportional to the cube of the thickness of the bridge. Meanwhile, the rigidity in the direction of the gliding face's protrusion is proportional to the thickness of the bridge. Therefore, by setting the bridge thickness at 2.0 μm when the void width is 10 μm, the restricting force of the bridges in the y direction can be reduced to ⅛ of that in the case where the void is filled in with the polymer material. Meanwhile, the restricting force in the direction of the gliding face's protrusion decreases by half. However, the protrusion toward the gliding face becomes close to that in the case with no void since the region in the vicinity of each heating element 21 is restricted in the x direction by each bridge for as long as 40 μm in the z direction.

Some modifications are possible in regard to the arrangement of the bridges formed in the void shown in FIG. 13. For example, it is possible to form two bridges in the vicinity of each heating element (21a, 21b). In this case, the bridge thickness leading to the y-direction restricting force (rigidity) equivalent to that in the polymer filling case is 1.4, 2.0, 2.7 and 3.1 μm when the void width is 3, 5, 8 and 10 μm. Incidentally, the y-direction rigidity of the bridge can be calculated based on the model of a beam with fixed ends. Thus, by setting the thickness of each of the two bridges (in the vicinity of each heating element) at ½ of the bridge thickness in the case where each heating element is provided with one bridge, the y-direction restricting force of the thermal actuator can be reduced to ¼ compared to the one-bridge-each case while keeping the other restricting force (for suppressing the gliding face's protrusion in the vicinity of the heating element) at the same level as that in the one-bridge-each case.

### [Another Example of Thermal Actuator Structure of Magnetic Head Slider]

### Embodiment 10-2

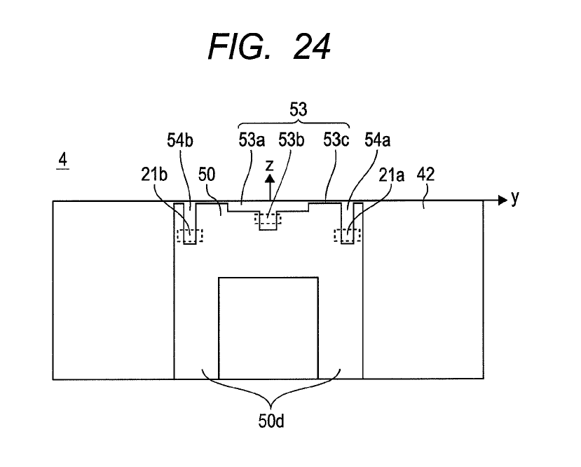

In this embodiment, the embodiment 4-3 shown in FIG. 23 (in which the void not open to the gliding face is formed along the y−z plane) is combined with the embodiment 10-1 shown in FIG. 13 (in which the bridges for suppressing the thermal expansion of the parts in the vicinity of the heating elements 21a and 21b toward the gliding face are formed nearby the centers of the heating elements, respectively). Referring to FIG. 24, bridges 54a and 54b extending in the −z direction are formed of alumina similarly to the thin film stack part 42 other than the void. Each bridge 54a, 54b is so long in the −z direction as to reach the bottom of each heating element 21a, 21b, while being narrow (3-10 μm) so as not to restrict the transverse thermal expansion in the vicinity of the heating element. Therefore, this embodiment has advantages in that the displacement efficiency of the read/write element is high, the void does not negatively affect the conventional slider air bearing properties, and the thermal expansion toward the gliding face due to the heating element can be suppressed. As a modification of this embodiment, it is also possible to combine the structure shown in FIG. 22 (in which the void is not open in the central area corresponding to the air bearing surface) and the structure shown in FIG. 13 (in which the bridges extending in the −z direction are formed nearby the centers of the heating elements 21a and 21b).

FIG. 14 shows a still another structural example of the magnetic head slider in accordance with the present invention, in which two bridges 601 and 602 are formed in the void 501 in order to suppress the protrusion toward the gliding face in the vicinity of the head caused by the single-side driving head positioning thermal actuator. In this example, the two bridges 601 and 602 for restricting the protrusion toward the gliding face are formed at the position corresponding to the region in the vicinity of the heating element 21a closer to the read/write element 20. The heating element 21c farther from the read/write element 20 is provided with no bridge since the protrusion toward the gliding face caused by the heating element 21c does not substantially affect the height of the head slider's gliding face. However, it is of course possible to add a bridge to the position corresponding to the heating element 21c when necessary. The width of the void 501 is 5-10 μm and the thickness of each bridge 601, 602 is 3-4 μm. The width of each bridge in the z direction is desired to be 50 μm (depth of the lower ends of the heating elements in the z direction) or more.

Incidentally, the embodiment of FIG. 14 having two voids 501 and 502 might involve a danger of deterioration in the force mechanically binding the read/write element and the heating elements to the slider body. Therefore, it is possible, as a modification of this embodiment, to provide a thin bridge, as long in the z direction as the depth of the voids 501 and 502, at the boundary between the voids 501 and 502. This example is advantageous in that the mechanical strength of the thermal actuator part can be increased without substantially restricting the displacement of the thermal actuator.

### [Another Example of Thermal Actuator Structure of Magnetic Head Slider]

### Embodiment 11

While all the above embodiments have been designed in order to increase the displacement efficiency of the thermal actuator, the ultimate goal regarding the thermal actuator is to increase the response speed of the head positioning thermal actuator. Therefore, an embodiment directly improving the response speed of the thermal actuator will be described below.

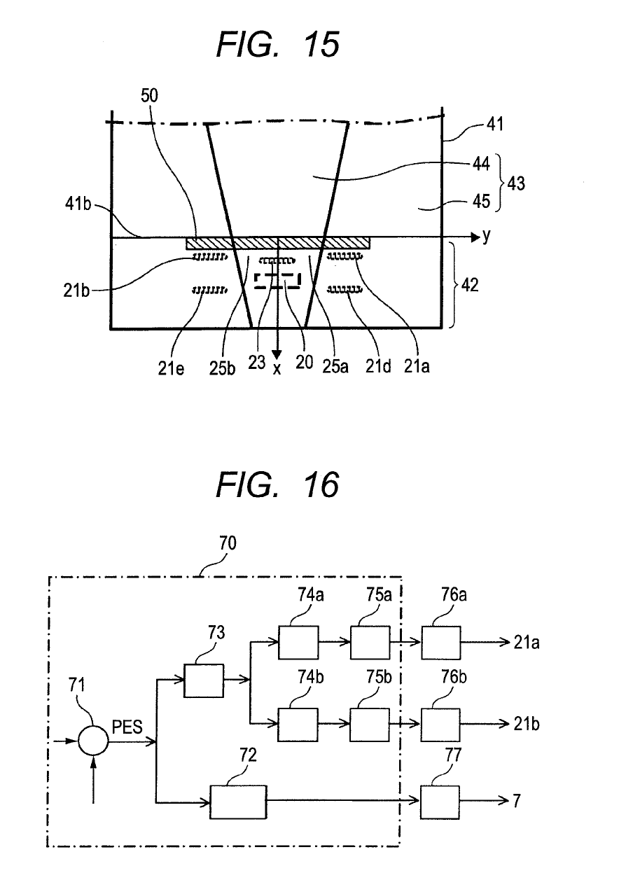

FIG. 15 shows a structural example in which the heating elements 21a and 21b are provided with additional heating elements 21d and 21e, respectively. The heating element 21d is arranged substantially at the same (y, z) position as the heating element 21a. Similarly, the heating element 21e is arranged substantially at the same (y, z) position as the heating element 21b. The position of the heating elements 21d and 21e in the x direction is around the center of the thickness of the thin film stack part 42. The heating element 21d is connected in series with the heating element 21a, and the heating element 21e is connected in series with the heating element 21b. Since the series-connected heating elements 21a and 21d, for example, are simultaneously heated by energization, the region in the thin film stack part 42 in the vicinity of these heating elements is heated instantly, with no time delay in the thickness direction of the thin film stack part.

In contrast, in the embodiment 1, the energization of the heating element 21a first causes the temperature rise in the several μm vicinity of the heating element 21a, simultaneously causing the thermal expansion in the same region. At the time point 0.1 ms after the energization, however, the temperature rise is still insufficient at positions in the thin film stack part 10 μm or more apart from the heating element 21a in the x direction, impeding the thermal expansion by the heating element 21a. At the time point 0.2-0.3 ms after the energization, the temperature of the central part of the thin film stack part rises sufficiently and the whole region in the thin film stack part around the y-position of the heating element 21a thermally expands sufficiently. Since the thermal expansion displacement of the whole region in the vicinity of the heating element 21a propagates in the −y direction at the speed of sound via the thermal expansion transmitting part 25a and displaces the read/write element in the −y direction, the transfer time (propagation time) is 10 ns or less. Therefore, the response time of the head displacement with respect to the input power to the heating element is dominated by heat propagation time in the vicinity of the heating element in the thickness direction of the thin film stack part 42 (at least approximately 0.2 ms in terms of the time constant).

Considering the above fact, the example of FIG. 15, in which two heating elements are arranged in the thickness direction of the thin film stack part 42 to instantly heat the thin film stack part across the whole thickness, is capable of increasing the time responsiveness of the thermal actuator by a factor of approximately 1.2. In cases where the thin film stack part is thicker, more than two (e.g., three) heating elements may be arranged in the thickness direction and connected in series. Incidentally, when two or more heating elements are arranged in the thickness direction, it is desirable that heating elements having appropriately different resistance values be used so that the temperature rise can be substantially uniform in the thin-film thickness direction, taking also the gliding face's cooling property into account.

By the embodiments described above, the restriction on the displacement by the thermal actuator is relaxed and the displacement efficiency is increased thanks to the low Young's modulus part formed in the thin film stack part facing the slider substrate. Further, by arranging two or more heating elements in the thickness direction of the thin film stack part and connecting the heating elements in series for the simultaneous energization as in the embodiment 11, a head positioning thermal actuator with not only the increased displacement efficiency but also the improved time responsiveness can be realized.

### [Magnetic Disk Drive Employing Head Positioning Thermal Actuator]

### Embodiment 12

In the following, the positioning control of the read/write element in the magnetic disk drive equipped with the magnetic head slider configured as the above embodiments will be described.

FIG. 16 shows control blocks for the positioning control of a two-stage actuator including a thermal actuator having heating elements on both sides of the head. The magnetic disk drive 1 has an MPU (MicroProcessing Unit) 70 mounted on the circuit board outside the enclosure 10. The MPU 70, functionally including a calculation circuit 71, a coarse movement control circuit 72 and fine movement control circuits 74 (74a and 74b), drives the voice coil motor 7 and the heating elements 21 and thereby makes the read/write element 20 follow an intended track (target track) formed on the magnetic disk 2.

The calculation circuit 71 calculates a position error signal PES representing the position error of the read/write element 20 with respect to the target track by obtaining the difference between the present position of the read/write element 20 (determined from servo data read out by the read/write element) and the target track (position) for the read/write element 20 (determined from a write command or a read command inputted from an external host computer). The coarse movement control circuit 72 generates a control command S_{V} for the voice coil motor 7 (for suppressing the position error of the read/write element 20) based on the error signal PES inputted from the calculation circuit 71 and outputs the control command S_{V} to the voice coil motor 7 via a motor driver 77.

Meanwhile, for the fine movement control circuits 74 (74a and 74b) for controlling the thermal actuator, a separation circuit 73 separates the error signal PES inputted from the calculation circuit 71 into components to be inputted to the heating elements 21a and 21b (collectively referred to as heating elements 21), respectively, in order to suppress the position error of the read/write element 20. Each fine movement control circuit 74 (74a, 74b), which is formed by a feedback control circuit, generates a control command S_{H} for making a corresponding heater driver 76 (76a, 76b) generate electric power proportional to an error correction signal to be inputted to the corresponding heating element 21 (21a, 21b). Each time delay compensator 75 (75a, 75b) is a phase-lead filter for correcting the delay in the responsiveness of the heating element 21. Each heater driver 76 (76a, 76b) outputs electric current or electric power proportional to the control command S_{H} to the corresponding heating element 21 (21a, 21b).

Incidentally, since the displacement of the read/write element 20 is proportional to the electric power (heating value) of the heating element 21 and the electric power of the heating element 21 is proportional to the square of the electric current of the heating element 21, the displacement control of the read/write element 20 can also be conducted by making the heater driver 76 execute the control so that the square of electric current of the heating element 21 is proportional to the position error correction signal. Since such a control method outputting electric power proportional to the control command is an already-known technique in the TFC (flying height control with the thermal actuator (heating element 23)), the control method can easily be applied to the magnetic disk drive according to this embodiment.

### [Improvement of Responsiveness by Phase-Lead Filter Having Inverse Property]

Here, the function and effect of the phase-lead filter, which converts the high displacement efficiency of the thermal actuator in accordance with the present invention into improvement in the displacement responsiveness, will be explained. As mentioned above, the displacement output of the thermal actuator in accordance with the present invention achieves excellently high displacement efficiency which is 3-6 times that (5 nm/50 mW) in the case where no voids, etc. are formed. However, the time constant of the thermal actuator for the stepwise power input is at least approximately 0.2 ms, which means that the control bandwidth of the thermal actuator is as narrow as 0.8 kHz. However, by using a phase-lead filter having a property inverse to that of the thermal actuator, the high displacement efficiency can be converted into a reduction in the time constant and an increase in the control bandwidth.

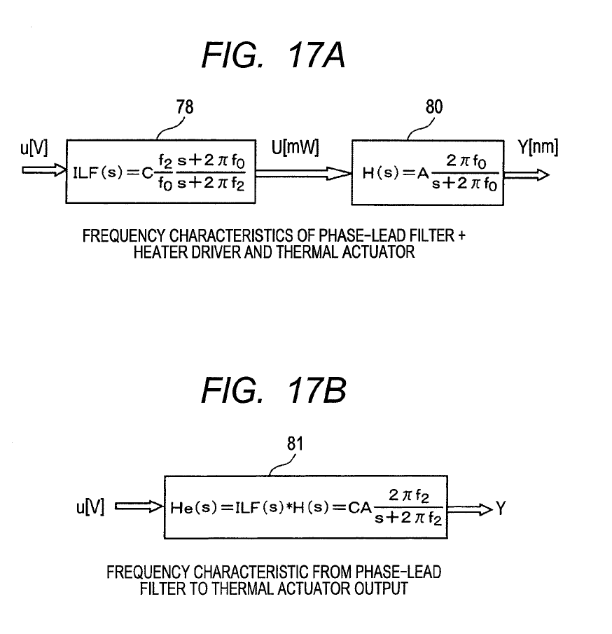

FIGS. 17A and 17B show the transfer property of a sine wave signal from the phase-lead filter to the thermal actuator. In FIG. 17A, the frequency characteristic from the phase-lead filter 75 to the heater driver 76 is represented by a transfer function 78, and the frequency characteristic from the thermal actuator's input power to the read/write element's displacement is represented by a transfer function 80. The transfer function 80 from the thermal actuator's input power to the read/write element's displacement is represented by the following expression (1) in a first-order lag system:

$$H ( s ) = A \frac{2 π {f}_{0}}{s + 2 π {f}_{0}} \qquad ( 1 )$$

In the expression (1), “f₀” represents the cutoff frequency where the displacement response of the thermal actuator to the input power decreases by 3 dB (to 70%). Assuming that the time constant in response to the stepwise input is τ, the relationship f₀=1/(2πτ) holds. “A” represents the displacement of the read/write element in response to stationary input power, which corresponds to the displacement efficiency. Meanwhile, the transfer function 78 from the phase-lead filter's input to the heater driver's output is represented by the following expression (2):

$$I L F ( s ) = C \frac{{f}_{2} s + 2 π {f}_{0}}{{f}_{0} s + 2 π {f}_{2}} \qquad ( 2 )$$

In the expression (2), the transfer function 78 is represented as “ILF(s)” in the sense of “Inverse Lead Filter” (phase-lead filter having the inverse property) since the numerator of the transfer function 78 is identical with the denominator of the transfer function 80 (expression (1)) of the thermal actuator (transfer function having the inverse property). Another property of the ILF(s) is that it amplifies the amplitudes of frequency components higher than f₀ (i.e., when f₂/f₀>1) and advances the phases of such frequency components. The coefficient C, representing a property of the heater driver, has a unit [mW/V] since the heater driver converts a control signal (generally processed as voltage) into electric power.

FIG. 17B shows a transfer function 81 from the phase-lead filter to the thermal actuator's displacement output. The transfer function 81, as the product of the expressions (1) and (2), is represented by the following expression (3):

$${H}_{e} ( s ) = I L F ( s ) * H ( s ) = CA \frac{2 π {f}_{2}}{s + 2 π {f}_{2}} \qquad ( 3 )$$

The expression (3) indicates that the cutoff frequency has increased to f₂ (>f₀) in the synthesized transfer property.

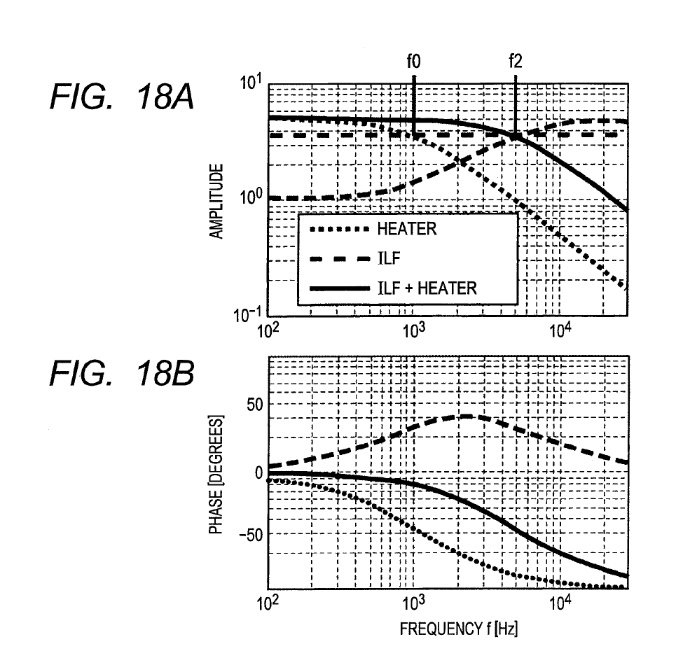

Here, if we assume that the cutoff frequency of the thermal actuator itself is 1 kHz and the displacement efficiency is 5 nm/10 mW (since the displacement efficiency has been increased 5 fold) for the sake of clarity, by letting f₀=1 kHz, f₂=5 kHz, A= 5/10 [nm/mW] and C=1 [mW/V] and substituting s=2πfi (i=(−)^{1/2}: imaginary unit) for “s” in the expressions (1), (2) and (3), the amplitude characteristics |H(2πfi)|, |ILF(2πfi)| and |He(2πfi)| of the transfer functions 80, 78 and 81 can be drawn as shown in FIG. 18A and the phase characteristics of the transfer functions 80, 78 and 81 can be drawn as shown in FIG. 18B. It is clear from FIG. 18A that the cutoff frequency (where the amplitude decreases to 70%) increases from f₀=1 kHz to f₂=5 kHz.

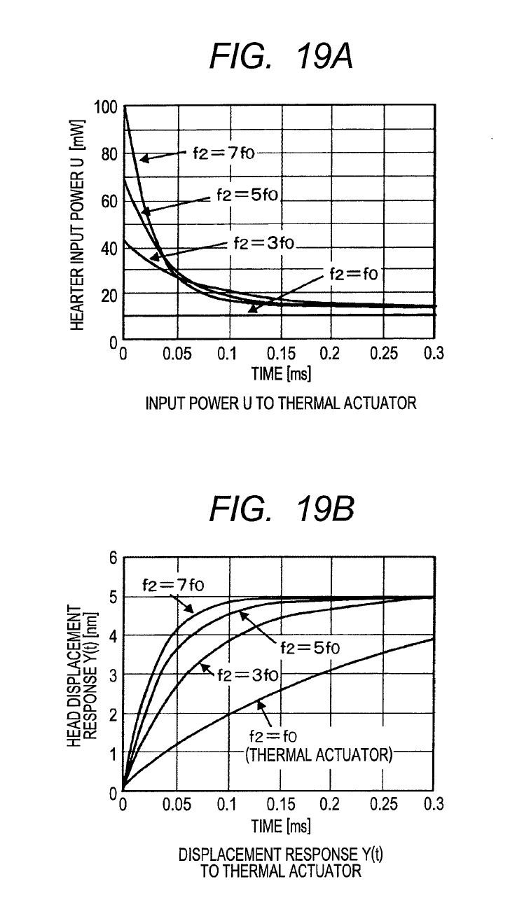

In order to clarify why the responsiveness can be increased by use of the phase-lead filter by increasing the displacement efficiency, the output U(t) of the phase-lead filter and the displacement response Y(t) of the thermal actuator when stepwise input voltage of 10 V is supplied as the phase-lead filter's input u(t) in FIGS. 17A and 17B are shown in FIGS. 19A and 19B in regard to cases where f₂/f₀=1, 3, 5 and 7. FIG. 19A clearly indicates that the input U(t) to the thermal actuator at the start of the input increases from 10 mW remarkably with the increase in the cutoff frequency f₂, by which the time constant of the thermal actuator's head displacement response is reduced by a factor of f₀/f₂ in each case and displacement output of 5 nm is achieved as shown in FIG. 19B.

What is important here is that the input power to the thermal actuator can not be increased without limitation since the heating temperature is limited. The maximum temperature at which physical properties of the materials of the heating elements and the parts in the vicinity of the heating elements do not change even with the repeated thermal stresses is considered to be approximately 500° C. at most. While the temperature rise is dependent on the cooling property of the heating element, the permissible input power is considered to be approximately 100 mW at most. Thus, in the case where the displacement efficiency of the thermal actuator is 5 nm/50 mW, the speeding up possible by the phase-lead filter is approximately 2-3 times at best.

Since the cutoff frequency required of the microactuator is 3 kHz or higher, the displacement efficiency is required to be at least approximately twice (5 nm/25 mW) in the case where the cutoff frequency of the thermal actuator itself is 0.8 kHz.

Incidentally, since the thermal actuator, the phase-lead filters and the heater drivers generally have high-frequency cutoff properties, the input power at the time 0 does not actually take on a finite value differently from FIG. 19A. The input power actually rises from 0 if closely observed. This property can be evaluated by adding a factor like (s+2πf₁) (f₁>>f₂) to the denominator of the transfer function of the thermal actuator or the phase-lead filter. Although not shown here, it has been demonstrated that the increase in the time constant and the decrease in the cutoff frequency are as small as 10% when f₁=30 f₀, for example.

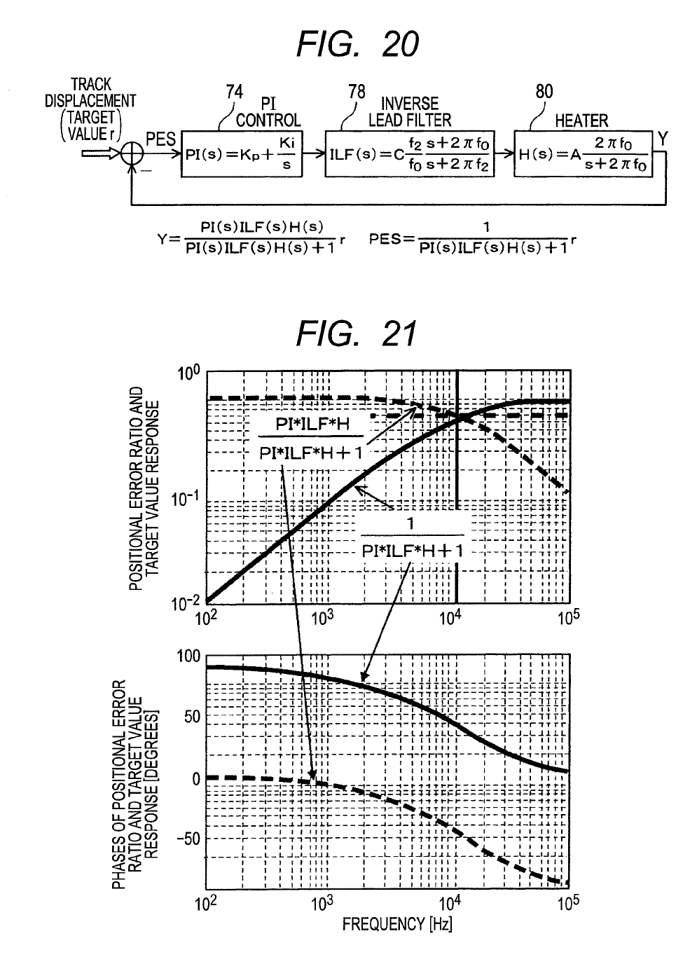

Next, the operation and effect of the feedback control circuit (fine movement control circuit) 74 in the control system of FIG. 16 will be explained. FIG. 20 shows the configuration of one of the thermal actuator control circuits shown in FIG. 16. The separation circuit 73 in FIG. 16 is left out in FIG. 20. Since the thermal actuator is a first-order lag system, the feedback control for compensating for the positioning error is executed by means of the proportional-integral control. In this case, the transfer function of the feedback control circuit is represented by the following expression (4):

$$PI ( s ) = {K}_{p} + \frac{{K}_{i}}{s} \qquad ( 4 )$$

In this case, the response from the track displacement (positioning target value) r to the read/write element's displacement Y and the response from the track displacement to the position error PES are given by the following expressions (5) and (6), respectively:

$$\begin{matrix}Y = \frac{PI ( s ) I L F ( s ) H ( s )}{PI ( s ) I L F ( s ) H ( s ) + 1} r & ( 5 ) \\ P E S = \frac{1}{PI ( s ) I L F ( s ) H ( s ) + 1} r & ( 6 )\end{matrix}$$

The amplitude characteristics and phase characteristics of Y/r and PES/r (given by the expressions (5) and (6)) when the proportional feedback gain Kₚ and the integral feedback gain Kᵢ of the position signal are set at Kₚ=0.5 [V/nm] and Kᵢ=2000 [V/nm·s] are shown in FIG. 21. As is clear from FIG. 21, the frequency at which the target value response characteristic drops to 70% and the position error increases to 70% is 10 kHz or higher. Therefore, a high-bandwidth positioning servomechanism can be realized. Although not shown here, even if the cutoff frequency of the thermal actuator changes by ±15% while the constants of the control circuit are fixed, the change in the control performance is little, which is indicative of high robustness of the control system. Incidentally, while the proportional-integral control is employed as the feedback control in the example of FIGS. 20 and 21, the double integral control may also be employed in order to increase the suppression ratio of the positioning error in the low-frequency part.

In the thermal actuator, the transfer time of the displacement from the heating element to the head is 10 ns or less as mentioned above, and thus the natural frequency of the transfer system is 50 MHz or higher. Therefore, the increasing of the control band frequency (control bandwidth) is not restricted by the natural vibration of the transfer system differently from conventional voice coil actuators and suspension-driving piezoelectric microactuators. However, major problems with the thermal actuator are low time responsiveness and low displacement efficiency. Further, the protrusion of the head's gliding face caused by the thermal actuator can also cause difficulties or failures. By the present invention, the displacement efficiency can be increased while minimizing the protrusion toward the gliding face, by which the time response and the control bandwidth can be increased.

According to the preferred embodiments of the present invention, the displacement efficiency can be increased to 5 times that of the heating element itself, and even to 10 times if the embodiment 9 can be implemented. Further, a cutoff frequency of as high as 1 kHz is presumed to be possible by use of two heating elements arranged in the thickness direction of the thin film stack part. Therefore, by combining these features, the control band frequency can be increased to 5-6 kHz by use of the phase-lead filters. By applying the feedback control to this configuration, a magnetic disk drive enabling a high track density corresponding to a control band frequency of 10 kHz or higher can be realized.

Incidentally, the functional configuration of the MPU 70 is not restricted to the above example. While the control of the voice coil motor 7 and the control of the heating elements 21 are independent of each other in the embodiments, it is also possible to input the control command S_{H} outputted by the fine movement control circuit 74 to the coarse movement control circuit 72 (via the gain model of the heating element 21) together with the error signal PES and thereby make the control of the voice coil motor 7 and the control of the heating elements 21 incoherent with each other.

Further, while the magnetic disk drive described in the above embodiments is equipped with the two-stage actuator including the voice coil motor 7 as the first stage and heating elements 21 as the second stage, the configuration of the thermal actuator is not restricted to this example. For example, the magnetic disk drive may also be equipped with a three-stage actuator further including a microactuator formed of piezoelectric elements, etc. Such a three-stage actuator can be implemented by employing the voice coil motor 7 as the first stage, the microactuator (for adjusting the position of the magnetic head slider 4A with respect to the head support part 6) as the second stage, and the heating elements 21 (thermal actuator) as the third stage.

What is claimed is:

1. A magnetic head slider flying above a rotating magnetic disk and reading and writing data from/to the magnetic disk, comprising:
a read/write element for executing the reading/writing of data;
at least one heating element arranged in a width direction of the magnetic head slider with respect to the read/write element for generating heat in response to energization;
a thermal expansion transmitting part lying between the heating element and the read/write element for transmitting thermal expansion caused by the heating of the heating element and thereby displacing the read/write element in the width direction; and
a thermal displacement restriction limiting part formed in a region covering at least part of the region of the thermal expansion transmitting part for limiting restriction on the displacement in the width direction by the thermal expansion transmitting part.

2. The magnetic head slider according to claim 1, wherein:
the magnetic head slider is made up of a slider substrate and a thin film stack part formed on a rear end face of the slider substrate, and
the thermal displacement restriction limiting part is configured as a low Young's modulus part which is made of a material having a Young's modulus lower than that of the thin film stack part, the thermal displacement restriction limiting part being formed in the thin film stack part facing the slider substrate so as to cover at least part of the read/write element, the thermal expansion transmitting part and the heating element in the width direction of the magnetic head slider.

3. The magnetic head slider according to claim 1, wherein the thermal displacement restriction limiting part is a void having prescribed width, depth and thickness.

4. The magnetic head slider according to claim 3, wherein the thermal displacement restriction limiting part is filled in with a nonconductive ceramics material and is not partially formed in a region forming an air bearing surface of the slider and in a region substantially corresponding to part of the area of a protrusion control heating element which is used for controlling protrusion of a gliding face of the slider.

5. The magnetic head slider according to claim 3, wherein:
the thermal displacement restriction limiting part is filled in with a nonconductive ceramics material in a region in the vicinity of a gliding face of the slider and in a region substantially corresponding to part of the area of a protrusion control heating element which is used for controlling protrusion of the gliding face so as not to be open to the gliding face, and
the void is formed to extend to a back surface of the slider opposite to the gliding face so as to be open to the back surface.

6. The magnetic head slider according to claim 3, wherein:
the void is filled in with a nonconductive ceramics material in a T-shape, and
the top of the T-shaped part forms an air bearing surface of a gliding face of the slider.

7. The magnetic head slider according to claim 2, wherein the low Young's modulus part is implemented by a low Young's modulus layer which is made of a material having a Young's modulus lower than that of the slider substrate and that of the thin film stack part.

8. The magnetic head slider according to claim 7, wherein thermal conductivity of the material forming the low Young's modulus layer is sufficiently lower than that of Al₂O₃TiC as the material of the slider substrate and at most lower than or equal to that of Al₂O₃ as the material of the thin film stack part.

9. The magnetic head slider according to claim 7, wherein the low Young's modulus layer extends over the whole interface between the slider substrate and the thin film stack part.

10. The magnetic head slider according to claim 7, wherein the low Young's modulus layer is made of a polymer material.

11. The magnetic head slider according to claim 2, wherein the thin film stack part includes:
a first thermal displacement restriction limiting part as the thermal displacement restriction limiting part containing at least part of the read/write element, the thermal expansion transmitting part and the heating element in the width direction of the magnetic head slider; and
a second thermal displacement restriction limiting part arranged to extend in a direction orthogonal to the width direction of the magnetic head slider.

12. The magnetic head slider according to claim 11, wherein the thin film stack part further includes a third thermal displacement restriction limiting part which is arranged in orthogonal to the first thermal displacement restriction limiting part and the second thermal displacement restriction limiting part.

13. The magnetic head slider according to claim 3, wherein:
the void covers the read/write element, the thermal expansion transmitting part and the heating element, and
the void is provided with one or more thin bridges each filling in the void at a position in the vicinity of the heating element.

14. The magnetic head slider according to claim 3, wherein:
the void is not open to an area forming an air bearing surface or to the slider's gliding face but is open to the slider's back surface, and
the void is provided with a thin bridge filling in the void at a position corresponding to the center of the heating element.

15. The magnetic head slider according to claim 12, wherein:
the first through third thermal displacement restriction limiting parts are implemented by voids, and
a bridge with a small thickness as a part for filling in the void with a prescribed material is formed between the first and second thermal displacement restriction limiting parts and/or between the second and third thermal displacement restriction limiting parts.

16. The magnetic head slider according to claim 1, further comprising one or more second heating elements arranged in parallel with the heating element serving as a first heating element,
wherein when two or more second heating elements are provided, the second heating elements are connected in series and driven by the same control power as input power.

17. A magnetic disk drive comprising:
a magnetic disk on which data are recorded along tracks;
a spindle motor for rotating the magnetic disk;
a magnetic head slider flying above the rotating magnetic disk and reading and writing data from/to the magnetic disk, the magnetic head slider including a read/write element for executing the reading/writing of data, at least one heating element arranged in a width direction of the magnetic head slider with respect to the read/write element for generating heat in response to energization, a thermal expansion transmitting part lying between the heating element and the read/write element for transmitting thermal expansion caused by the heating of the heating element and thereby displacing the read/write element in the width direction, and a thermal displacement restriction limiting part formed in a region covering at least part of the region of the thermal expansion transmitting part for limiting restriction on the displacement in the width direction by the thermal expansion transmitting part;
a heating control circuit including a phase-lead filter with a property inverse to that of the heating element and controlling and driving the heating element;
a head support part for supporting the magnetic head slider;
a voice coil motor for driving the head support part and thereby moving the magnetic head slider relative to the magnetic disk;
a calculation circuit for calculating a position error of the read/write element with respect to the track based on data read out by the read/write element;
a coarse movement control circuit for driving the voice coil motor based on the position error of the read/write element; and
a fine movement control circuit for energizing the heating element based on the position error of the read/write element.

18. The magnetic disk drive according to claim 17, wherein:
the magnetic head slider includes the heating element on each side of the read/write element in regard to a transverse direction, and
electric power proportional to a positive value of a position error signal regarding the position error of the read/write element with respect to the track is inputted from the heating control circuit to one heating element, and
electric power proportional to a negative value of the position error signal is inputted from the heating control circuit to the other heating element, and
the read/write element is displaced due to thermal expansion in the vicinity of the energized heating element, and
feedback control is conducted so as to minimize position error caused by the displacement.

19. The magnetic disk drive according to claim 17, wherein:
the magnetic head slider includes first and second heating elements on one side of the read/write element in regard to a transverse direction, and
DC power corresponding to a center position of the positioning of the read/write element is applied by the heating control circuit to the second heating element farther from the read/write element, and
electric power proportional to a positive value of a position error signal regarding the position error of the read/write element with respect to the track is inputted from the heating control circuit to the first heating element, and
electric power proportional to a negative value of the position error signal is inputted from the heating control circuit to the second heating element, and
the read/write element is displaced due to thermal expansion in the vicinity of the first and second heating elements, and
feedback control is conducted so as to minimize the position error.
